(19) United States
(12) Patent Application Publication
(10) Pub. No.: US 2016/0118157 A1
(43) Pub. Date: Apr. 28, 2016

(54) CARBON NANOTUBE COMPOSITE CONDUCTORS

(71) Applicant: LOS ALAMOS NATIONAL SECURITY, LLC, Los Alamos, NM (US)

(72) Inventor: Terry G. Holesinger, Los Alamos, NM (US)

(21) Appl. No.: 14/893,771

(22) PCT Filed: May 23, 2014
(86) PCT No.: PCT/US14/00131

§ 371 Date: Nov. 24, 2015

Related U.S. Application Data
(60) Provisional application No. 61/827,168, filed on May 24, 2013.

(51) Int. Cl. H01B 3/00; H01B 3/30; H01B 1/02; H01B 3/12; C01B 31/02; B21C 1/02

(52) U.S. Cl. CPC H01B 3/004; C01B 31/022; B21C 1/02; H01B 1/023; H01B 1/026; H01B 3/12; H01B 3/30; C01B 2202/22

(57) ABSTRACT

Provided are composites that exhibit improved conductivity characteristics as compared to existing conductors. The disclosed conductive composites include a substrate—e.g., a wire that is surmounted by a coating of carbon nanotubes. Substrates may be metals, ceramics, polymers (conducting, non-conducting, and semiconducting) The composites may also include metallic, ceramic, or polymeric materials—such as nanoparticles—that are disposed on or even disposed within the nanotube coatings. Also provided are related methods of fabricating the disclosed composites.

### CROSS-REFERENCE TO RELATED APPLICATIONS

The present application is a national phase filing of PCT application number PCT/US2014/00131, with an international filing date of May 23, 2014, which claims priority to and the benefit of U.S. nonprovisional patent application No. 61/827,168, entitled “Carbon Nanotube Composite Conductors” and filed May 24, 2013, the disclosures of which are each incorporated herein by reference in its entirety for all purposes.

### BACKGROUND

1. Technical Field

The present disclosure relates to the field of carbon nanotubes and to the field of composite conductor materials.

2. Description of the Related Art

Conventional conductor materials (e.g., wires) can be heavy, particularly in the case of conductive materials as copper, steel, and other metals. The conductivity of these materials can be improved by increasing the amount of material (e.g., by increasing the wire diameter), but such increases in conductivity are normally accompanied by increases in weight and expense. Accordingly, there is a need in the art for materials having improved conductivity characteristics. There is a related need for methods of fabricating such materials.

### SUMMARY

In meeting the disclosed challenges, the present disclosure provides conductive structures. These structures suitably include an elongate substrate (e.g., a wire) surmounted by a coating comprising carbon nanotubes, the elongate substrate having a major axis, and at least a portion of the carbon nanotubes of the coating being aligned with the major axis.

The present disclosure also provides methods of forming conductive structures. These methods may include contacting (a) an elongate substrate and (b) a population of carbon nanotubes dispersed in a fluid medium so as to give rise to an article having a coating of nanotubes that surmounts at least a portion of the elongate substrate; and drawing the article so as to reduce a cross-sectional dimension of the article.

The present disclosure also provides an assemblage of carbon nanotubes. The assemblages are characterized as being essentially tubular in configuration, the assemblage having a major axis, and at least some of the carbon nanotubes being oriented along the major axis.

### BRIEF DESCRIPTION OF THE DRAWINGS

The summary, as well as the following detailed description, is further understood when read in conjunction with the appended drawings. For the purpose of illustrating the disclosed technology, there are shown in the drawings exemplary embodiments; however, the disclosure is not limited to the specific methods, compositions, and devices disclosed. In addition, the drawings are not necessarily drawn to scale or proportion. In the drawings:

FIG. 1 provides images of CNT-coated wire substrates according to the present disclosure;

FIG. 2 provides exemplary data for Cu and Al substrate materials;

FIG. 3 provides images of CNT-coated wire substrates according to the present disclosure with calculated resistivity and conductivity data for a CNT-Cu composite wire and the CNT coating on the Cu wire substrate;

FIG. 4 provides images of CNT-coated wire substrates according to the present disclosure with calculated resistivity and conductivity data for a CNT-Al composite wire and the CNT coating on the Al wire substrate;

FIG. 5 provides images and data for CNT-coated wires bearing multiple coating layers;

FIG. 6 provides images and data for CNT-coated wires bearing multiple coating layers;

FIG. 7 provides images for CNT-coated wires that include Cu nanoparticles disposed within the CNT coating;

FIG. 8 provides exemplary performance data for CNT-coated wires according to the present disclosure, including wires containing Cu and Fe nanoparticulate;

FIG. 9 provides exemplary performance data for CNT-coated wires according to the present disclosure, the wire coating comprising a mixture of double-wall nanotubes (DWNTs) and (multiwall nanotubes) MWNTs;

FIG. 10 provides exemplary performance data for CNT-coated wires according to the present disclosure, the wires being prepared in the same manner using a mixture of DWNTs and MWNTs;

FIG. 11 provides exemplary physical and performance data for CNT-coated wires according to the present disclosure;

FIG. 12 provides exemplary physical data for CNT-coated wires according to the present disclosure;

FIG. 13 provides non-limiting embodiments of the disclosed methods;

FIG. 14 provides non-limiting embodiments of CNT dispersion fluids useful in the disclosed methods;

FIG. 15 provides an exemplary process flow for fabricating the disclosed conductor materials;

FIG. 16 provides an exemplary process flow for fabricating the disclosed conductor materials;

FIG. 17 provides an exemplary process flow for processing the disclosed conductor materials;

FIG. 18 provides exemplary solution pathways for fabricating the disclosed conductor materials;

FIG. 19 provides exemplary methods for incorporating particulates into the CNT coatings of the disclosed conductors;

FIG. 20 depicts an exemplary shear stirring method useful to disperse and realign CNTs in a fluid; CNT Coating Solutions Preparation—Shear Stirring;

FIG. 21 depicts an exemplary shear stirring method that uses stirrer tines, the methods being useful in dispersing and re-aligning CNTs in a fluid;

FIG. 22 depicts an exemplary method of aligning CNTs on a wire substrate;

FIG. 23 depicts an exemplary method of aligning CNTs of various lengths, spanning the micron to cm scales, along a wire substrate;

FIG. 24 depicts an exemplary method of applying a CNT coating to a wire substrate by removing the wire from the CNT fluid;

FIG. 25 depicts an exemplary method of applying a CNT coating to a wire substrate by way of a traveling fluid bead;

FIG. 26 provides further exemplary methods of aligning CNTs on a wire substrate;

FIG. 27 depicts aligning CNTs in a wire coating via wire drawing;

FIG. 28 depicts aligning CNTs in a wire coating via wire drawing and a twisting motion;

FIG. 29 depicts a reel-to-reel method for applying a CNT coating to a wire;

FIG. 30 depicts exemplary data from conductors according to the present disclosure;

FIG. 31 depicts images of exemplary conductor materials according to the present disclosure, showing (upper) a CNT coating dried onto a wire; (middle) a CNT coating aligned via a drawing process with twist; (lower) a CNT coating aligned via a drawing process;

FIG. 32 provides exemplary data for a CNT-coated wire formed by application of CNTs in an aqueous solution with a surfactant, process for adding Cu particulate precursors to the CNT coating, and process for thermally finishing said CNT-coated wire;

FIG. 33 provides exemplary images of a CNT-coated wire formed by a twist-draw process (left) and a CNT-coated wire having Cu nanoparticles disposed within;

FIG. 34 provides exemplary data (and image) of a CNT-coated wire with Cu nanoparticles disposed within the coating;

FIG. 35 provides an exemplary fabrication process for a CNT-coated wire and data for the fabricated conductor;

FIG. 36 illustrates post-processed conductors with a dried CNT coating (upper) and that undergo drawing (lower);

FIG. 37 illustrates post-processed conductors with a dried CNT coating (left) and that undergo drawing (right); Sample:

FIG. 38 provides SEI (left) and backscattered (right) images of a CNT-coated wire with Cu nanoparticles dispersed within the coating;

FIG. 39 provides an exemplary process for fabricating a CNT-coated wire with Cu nanoparticles disposed within the coating and exemplary data for the resultant conductor with nanoparticles aligned along the major wire axis after wire drawing;

FIG. 40 provides exemplary results from an illustrative sample;

FIG. 41 provides exemplary results from an illustrative sample;

FIG. 42 provides exemplary results from an illustrative sample with Cu nanoparticles within the CNT coating;

FIG. 43 provides exemplary results from an illustrative sample with Cu nanoparticles within the CNT coating;

FIG. 44 provides exemplary results from an illustrative sample with Cu physical vapor deposition (PVD) to form a continuous metal coating over the CNT coating;

FIG. 45 provides exemplary results from an illustrative sample with a Cu matrix disposed about the CNT coating, said matrix disposed by electroplating;

FIG. 46 provides exemplary results from an illustrative sample with MWNTs in an acidic solution;

FIG. 47 provides exemplary results from an illustrative sample with aligned CNTs in the coating;

FIG. 48 provides exemplary results from an illustrative sample with multiple CNT coatings;

FIG. 49 provides exemplary images from an illustrative sample with a CNT coating;

FIG. 50 provides SEI/BEI images of an illustrative sample with multiple CNT coatings;

FIG. 51 provides images of a recoated, annealed sample;

FIG. 52 provides exemplary images of a CNT coated wire produced with a mixture of single-wall nanotubes (SWNTs) and MWNTs that undergoes forward and reverse draw as well as the experimental protocol for producing the sample;

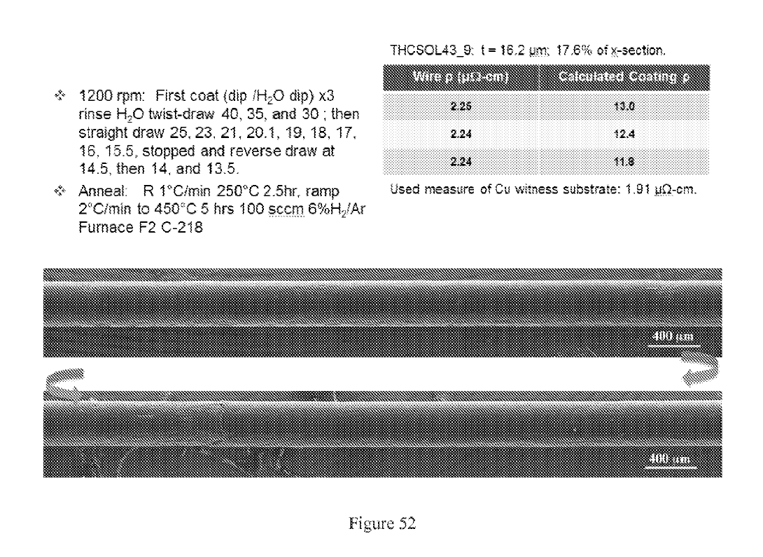

FIG. 53 provides additional magnification of the sample of FIG. 52;

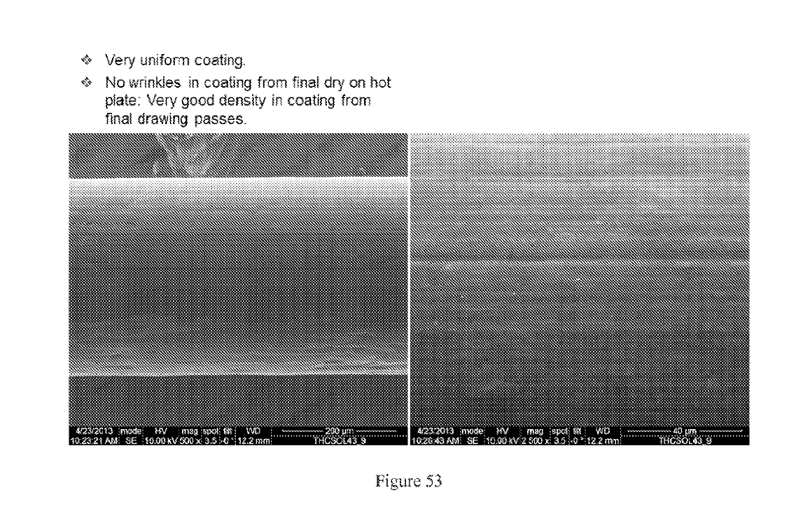

FIG. 54 provides additional magnification of the sample of FIG. 53, said CNT coating comprised of a mixture of SWNTs and MWNTs;

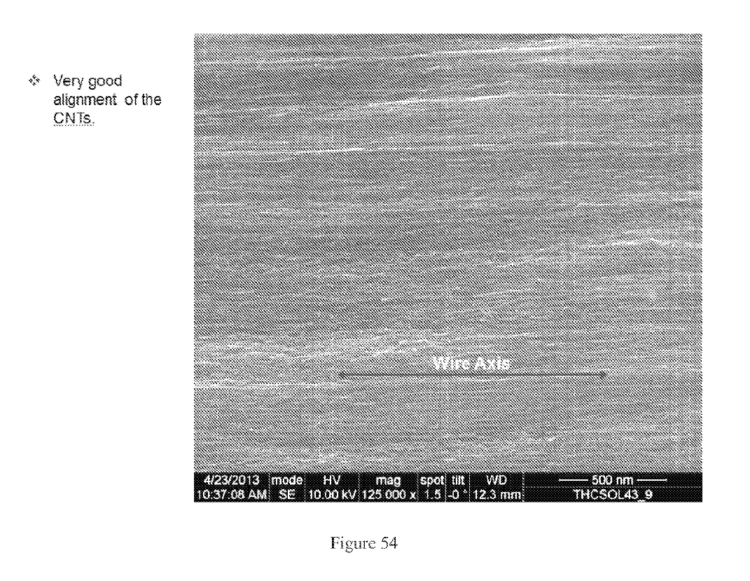

FIG. 55 provides images of exemplary CNT tubing formed by etching away the substrate beneath a CNT coating;

FIG. 56 provides additional magnification of the tubing of FIG. 55; and

FIG. 57 provides optical micrographs of (a) a CNT coated wire with a Cu coating, (b) a bare CNT coated wire, and (c) a close-up of the end of a coated wire showing the Cu core wire and CNT coating.

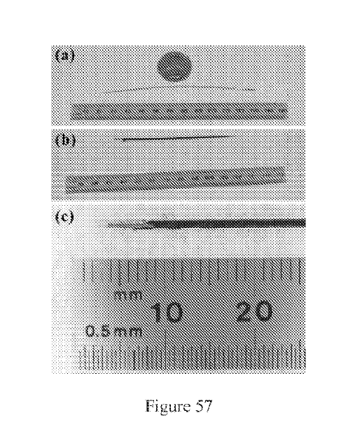

### DETAILED DESCRIPTION

The present disclosure may be understood more readily by reference to the following detailed description taken in connection with the accompanying figures and examples, which form a part of this disclosure. It is to be understood that this disclosure is not limited to the specific devices, methods, applications, conditions or parameters described and/or shown herein, and that the terminology used herein is for the purpose of describing particular embodiments by way of example only and is not intended to be limiting of the claims. Also, as used in the specification including the appended claims, the singular forms “a,” “an,” and “the” include the plural, and reference to a particular numerical value includes at least that particular value, unless the context clearly dictates otherwise. The term “plurality,” as used herein, means more than one. When a range of values is expressed, another embodiment includes from the one particular value and/or to the other particular value. Similarly, when values are expressed as approximations, by use of the antecedent “approximately” or “about,” it will be understood that the particular value forms another embodiment. All ranges are inclusive and combinable, and all documents cited herein are incorporated by reference in their entireties for any and all purposes.

It is to be appreciated that certain features of the disclosure which are, for clarity, described herein in the context of separate embodiments, may also be provided in combination in a single embodiment. Conversely, various features of the invention that are, for brevity, described in the context of a single embodiment, may also be provided separately or in any subcombination. Further, reference to values stated in ranges include each and every value within that range.

In one aspect, the present disclosure provides conductive structures. These structures suitably include an elongate substrate (e.g., a wire or tape) surmounted by a coating comprising carbon nanotubes. The elongate substrate suitably defines a major axis, and at least a portion of the carbon nanotubes of the coating are aligned with the major axis, although this is not a requirement, as it is not necessary for the carbon nanotubes of the coating to be aligned with the major axis.

The substrate is suitably elongate in conformation. A suitable substrate may have an aspect ratio in the range of from about 1:5 (i.e., cross-section:length) to about 1:1,000,000, or even greater. There is no particular limit to the length of the substrate as compared to the substrate's cross-section; equipment and processing constraints that are specific to a particular user may dictate the substrate's dimensions. A substrate may define a length of, e.g., 10 cm, 100 cm, 10 m, 50 m, or even greater, depending on the needs of the user. It should be understood that substrates—and finished composites—may be glued, sewn, tied, braided, soldered together, or otherwise attached or connected to one another. As one example, CNT-coated wire substrates may be braided or twisted together to form a longer article. Standard-gauge wires are considered especially suitable substrates.

Suitable substrates may comprises a variety of materials, including metals, ceramics, and combinations thereof. Metals are considered especially suitable substrate materials; copper, aluminum, steel (including stainless steel) are considered suitable. Boron is another suitable substrate material, as is alumina. Substrate materials are suitably ductile in character, although this is not a requirement. Polymer substrates—e.g., polyamides, polypropylenes, polyethylenes, and the like—are also suitable, and it should be understood that polymeric substrate may be include conducting polymer or non-conducting polymer.

A substrate may define a cross-sectional dimension (e.g., radius, diameter, thickness) in the range of from about 0.05 mm to about 5 mm or even up to about 5 cm, as well as intermediate values. Substrates having a cross-sectional dimension in the range of from about 0.1 mm to about 1 cm, or from about 0.5 mm to about 0.5 cm, or even from about 1 mm to about 0.1 cm are all considered suitable.

A substrate—e.g., a wire—may define a length along its major axis of about 1 mm or greater. Suitable lengths may be in the range of from about 10 cm to about 500 m, or from about 50 cm to about 100 m, or from about 100 cm to about 10 m, or even from about 0.5 m to about 5 m. Suitable substrates may be purchased commercially. It should be understood that a substrate may be abraded or otherwise roughened; without being bound to any particular theory, such treatment may enhance nanotube adherence to the substrate.

Coatings of the disclosed structures may suitably define a thickness in the range of from about 0.5 micrometers to about 2 mm, or from about 1 micrometer to about 1 mm, or even in the range of from about 10 micrometers to about 0.1 mm. In some embodiments, at least some of the carbon nanotubes of the coating have a length in the range of from about 5 micrometers to about 5 mm. At least some of the carbon nanotubes in a coating may have a cross-sectional dimension in the range of from about 2 nm to about 200 nm. The coating may have a cross-sectional dimension in the range of from about 1% of the conductive material to about 90% or even about 95% of the conductive material.

Coatings may include single-wall or multi-wall (including double-wall) carbon nanotubes. It should be understood that a coating may include a mixture of two or more kinds of nanotubes. A substrate may also be surmounted by multiple layers of nanotubes, e.g., a first layer of SWNTs, a second layer of DWNTs, and the like. Suitable carbon nanotubes are commercially available and can also be grown by the user using, e.g., forest growth techniques known to those of ordinary skill in the art. Multiwall CNTs (MWCNTs or MWNTs, which includes DWNTs) may be grown by a CVD process, e.g., on an iron catalyst film which is on an alumina buffer layer on a silicon wafer. Exemplary, non-limiting lengths range from 500 microns to 5 mm. Typical lengths of CNTs may be in the range of from about 1 mm to about 3 mm.

A coating may include a homogeneous population of carbon nanotubes, but may also include a heterogeneous population of carbon nanotubes. In some non-limiting embodiments, the ratio, by number, of single-wall or double-wall to multi-wall carbon nanotubes in the coating is in the range of from about 1:1000 to about 1000:1, or even in the range of from about 1:10 to about 10:1. It should be understood that a coating may include at least two carbon nanotubes that differ from one another in terms of number of walls, cross-sectional dimension, surface functionality, or any combination thereof. For example, an article might include a first (inner) coating of SWNTs and then a second (outer) coating of MWNTs.

The coatings of the present disclosure may also include particulates, e.g., nanoparticles, nanorods, nanoplatelets, and the like. The particulates may be characterized as being disposed on the coating, as being disposed in the coating, or even on and within the coating. Particulates may include a conductive material, e.g., a metal. Copper, silver, gold, aluminum, iron, and other conductive metals are all considered especially suitable for use as particulates. At least some of the particulates in a coating may define a cross-sectional dimension in the range of from about 1 nm to about 1000 nm, or in the range of from about 10 nm to about 500 nm, or even in the range of from about 50 nm to about 100 nm. The particulates may, in some embodiments, form a continuous matrix on the outside or within the coating. Without being bound to any particular theory, the presence of particulates may alter the conductivity and/or physical properties of the structures. As described elsewhere herein, metal may be applied to a CNT coating by physical vapor deposition, sputtering, chemical vapor deposition, electroplating, dip coating, and other techniques known to those of ordinary skill in the art. It should be understood that an article may include particulates that differ from one another in size, composition, or even both. For example, an article might include a population of 50 nm Cu particles and a population of 100 nm Au particles. It should be understood that a user may also include a conductive polymer within, on, or both within and on the CNT coating. A non-exclusive list of such polymers includes polyaniline, polythiophene, polyfluorenes, polyphenylenes, polypyrenes, polyazulenes, polynaphthalenes, poly(pyrrole)s (PPY), polycarbazoles, polyindoles, polyazepines, poly(thiophene)s (PT), poly(3,4-ethylenedioxythiophene) (PEDOT), poly(p-phenylene sulfide) (PPS), poly(acetylene)s (PAC), poly(p-phenylene vinylene) (PPV), and the like. Non-conducting or even semi-conducting polymers may also be present within, on, or even on and within the CNT coatings.

It should also be understood that the coating may include a ceramic material (e.g., titanium oxide, aluminum oxide, zirconia, magnesia, and others). The ceramic may be present as a coating, as particulate matter, or even as a continuous or semi-continuous matrix. Ceramic particulate material may, in some embodiments, be of a dimension like that of the metallic particulates described elsewhere herein. A user may dispose such a particulate material within or on the CNT coating according to methods known to those of ordinary skill in the art, e.g., dip-coating, impregnation, spraying, and the like The ceramic may be insulating, semiconducting, or even conducting.

As shown in the attached figures—described elsewhere herein in further detail—the disclosed structures may be in the form of wires. The disclosed materials may, in some embodiments, be at least partially enclosed within an insulating material. The insulating material may be a rubber, a plastic, a glass, or other insulating material.

The conductive structures may, in some embodiments, have a conductivity in the range of from about 0.1×10⁶ S/m to about 6×10⁹ S/m or even to about 6×10¹⁰ S/m. These values—as described elsewhere herein—represent an improvement over the comparative conductivity of a bare substrate material. In some embodiments, the disclosed conductive structures—including their carbon nanotube coatings—exhibit an improvement in conductivity over a bare substrate material of 0.1× to about 10,000×, or from about 5× to about 500×, or from about 10× to about 100×. The coating of the disclosed structures may also be characterized as having less than the resistance of the substrate. In some embodiments, the coating has about 90%, about 80%, about 70%, about 60%, about 50%, about 40%, about 30%, about 20%, about 10%, or even about 5% (or less) of the resistivity of the substrate.

The present disclosure also provides methods of forming conductive structures. These methods may include contacting (a) an elongate substrate and (b) a population of carbon nanotubes dispersed in a fluid medium so as to give rise to an article having a coating of nanotubes that surmounts at least a portion of the elongate substrate; and drawing the article so as to reduce a cross-sectional dimension of the article. Without being bound to any single theory, it is believed that drawing the article effects alignment of carbon nanotubes in the coating.

Drawing may be—as shown in the attached figures—linear motion. Drawing may also include curvilinear motion and also twisting in some embodiments. Without being bound to any particular theory, it is believed that drawing aligns the CNTs in the coating.

The population of carbon nanotubes is suitably dispersed in a fluid medium; suitable fluid media are described elsewhere herein. Exemplary concentration of CNTs may be, e.g., from 0.01 mg/ml to 10.25 mg/ml, although this range is not exclusive, as one may also use concentrations in the range of 2.5 mg/ml to 25 mg/ml. It should be understood that the user may use essentially any concentration of CNTs in solution.

Without being bound to any particular theory or embodiment, assuming a density for CNTs of 1.4 g/cm³, one may estimate the amount of CNTs per surface area of the coating to range from 0.7 mg/cm² for a 5 micron thick coating to 70 mg/cm² for a 500 micron thick coating. For the wires dipped in solution, all of the surface area contacted with solution is covered with CNTs. Multiple dips of the substrate with a rotation of the substrate in between each dip helps to develop a uniform coating around the circumference of the wire. The population of carbon nanotubes may include at least two carbon nanotubes that differ from one another in terms of number of walls, cross-sectional dimension, surface functionality, or any combination thereof. Suitable carbon nanotubes are described elsewhere herein.

The fluid may include water, a dispersant (e.g., a surfactant), and carbon nanotubes. The fluid may also include acid and/or salt (e.g., KI, KCl, NaCl). A variety of acids may be used, e.g., sulfuric, nitric, hydrochloric, and others; sulfuric acid is considered especially suitable, as are other acids that include sulfur and/or nitrogen. A fluid may include at least 50 mg CNTs/400 ml of fluid. Certain exemplary fluids are described below:

The drawing suitably effects a reduction in the cross-sectional dimension of the substrate of between about 0.1% and about 99%, or between about 1% and about 90%, or between about 5% and about 50%, or even from about 10% to about 25%. It should be understood that the drawing may be effected in a single step or even under multiple steps. Drawing may be performed on a coated substrate that has been dried following contact with the carbon nanotube-containing fluid, although it is not necessary that the substrate to be drawn is also dried. The drawing may be effected under heat, reduced pressure, increased pressure, or some combination of these. The drawing may also be performed under acidic, neutral, or even basic conditions. The speed of the drawing may vary according to the user's needs and the particular result desired; suitable drawing conditions will be known to those of ordinary skill in the art.

In some embodiments, the carbon nanotubes are stirred during the contacting. Without being bound to any single theory, it is believed that the stirring enhances interactions and adherence between the carbon nanotubes and the substrate. The stirring may a standard circular stirring, but agitation and other non-linear stirring technique are also suitable. The stirring may, in some embodiments, act to align the CNTs in the fluid.

As described elsewhere herein, the methods may be applied to an abraded (e.g., roughened) substrate. The user may abrade the substrate before contacting the substrate to the population of carbon nanotubes. Users may also dispose a plurality of particulates on the coating, within the coating, or both—suitable particulates are described elsewhere herein. The user may contact the coating directly to the particulates (e.g., dispersed in a fluid). Alternatively, the user may contact the coating with a metal salt and perform further processing (e.g., heating) to form particulates from the metal salt. In some embodiments, the particulates may already be present in the fluid that contains the carbon nanotubes. As one such example, a user might contact a substrate with a fluid that contains CNTs and also contains Cu nanoparticles.

The methods may also include annealing the substrate after contacting the substrate and the population of carbon nanotubes. The annealing may be performed in the presence of a noble or other inert gas, or even in the presence of hydrogen. Annealing may be performed at a temperature of about 25 deg. C. to about 900 or even about 1000 deg. C. Annealing may be performed for from about minutes to about 1, 5, or even 10 hours.

The user may also remove at least a portion of the elongate substrate. This may be accomplished by heating, application of acid and/or base, or by other techniques. By removing at least of the underlying substrate, the user may give rise to a hollowed shell or tube of carbon nanotubes.

After processing a CNT coated conductor (e.g., Cu core), and performing the drawing steps to align and density the CNTs, one can dry the wire, then soak in plain water or other fluid whereby acid that had dried within the coating can redissolve into the water and start to etch away the Cu core. After sufficient time, contact between the Cu core wire and the coating is reduced or even broken and the coating can slip off as CNT tubing. The resultant tubing may be used as, e.g., an antennas, filters, use in separations, as molds for other materials like polymers to form high strength polymeric fibers. In filters and other applications, the strength of the CNTs can make the filters much stronger than conventional devices. A user may also remove the core by heating, chemically etching, or by other methods known to those of ordinary skill in the art.

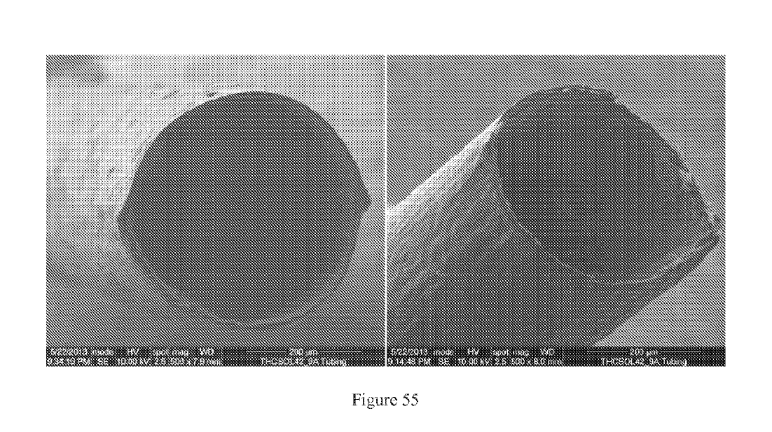

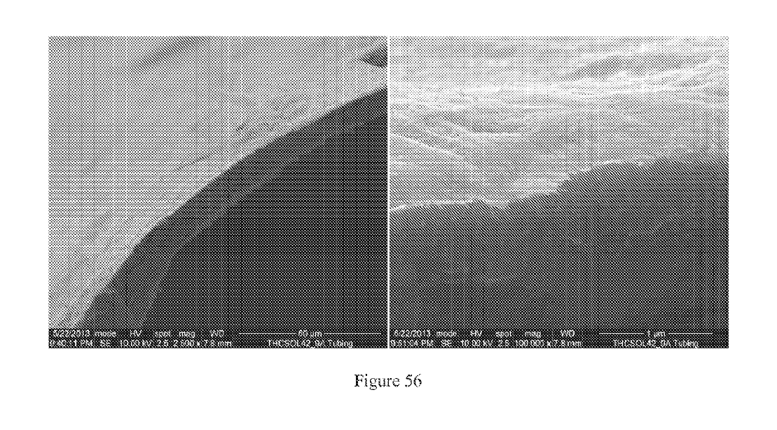

FIG. 55 provides images of exemplary CNT tubing made according to the present disclosure. The tubing was symmetric and could be cut with a knife. FIG. 56 provides additional magnification of the tubing, showing well defined wall structures and alignment of the CNTs along the tubing axis from the original deposition process. Also shown is nanoparticle decoration of the CNTs within the walls (Cu nanoparticles).

As described above, the present disclosure thus also provides an assemblage of carbon nanotubes. The assemblages are characterized as being essentially tubular in configuration, the assemblage having a major axis, and at least some of the carbon nanotubes being oriented along the major axis. The assemblage may, in some embodiments, be characterized as the coating of the disclosed coating/substrate materials. An assemblage according to the present disclosure may define a thickness in the range of from about 0.5 microns to about 2 mm. The interior channel of the tubing (e.g., FIG. 55) suitably has dimensions that correspond to the dimensions of the substrate on which the CNT coating had been formed.

Nanotubes suitable for the coatings described elsewhere herein are considered suitable for the disclosed assemblages. As described elsewhere herein, CNTs may have a length in the direction of the major axis of at least about 0.1 micrometers to about 5 mm, 10 mm, 50 mm, or even longer. As described elsewhere herein, an assemblage may include single-wall and/or multi-wall (including double-carbon nanotubes. Assemblages may include particulates disposed thereon, therein, or both—suitable particulates are described elsewhere herein.

### Additional Disclosure

Further disclosure is now provided by reference to the attached figures.

Standard four-probe resistivity measurements were performed to determine the overall CNT composite wire performance and to calculate the conductivity (resistivity) of the CNT coating. Accurate measurements of wire and substrate dimensions were obtained with a laser micrometer system. The CNT coating resistivity values were obtained by calculating the parallel resistance value of the coating and wire substrate, given the dimensions of the overall wire and copper wire substrate. 1/Rwire=1/RCNT+1/RCu

Solving for the resistivity (pCNT) of the CNT coating, we obtain:

pCNT=(Awire−ACu)*(pCu*pwire)/(Awire*pCu−ACu*pwire)

The cross-sectional areas, Awire and ACu, and resistivities, pwire and pCu, refer to the fully-processed coated wires and Cu wire substrates, respectively. A section of each wire substrate was set aside to act as the witness sample during the processing of a CNT composite wire. The witness sample was cut directly adjacent to the section of wire to be coated and was used to provide the measure of the core resistivity in the calculation of the CNT coating resistivity. This witness wire was given all heat treatments given to the coated wires. For reference, the International Annealed Copper Standard (IACS) is 5.8×10⁷ S/m (1.72 μΩ-cm) at 20° C. Aluminum values are 3.54×10⁷ S/m (61% IACS) or 2.83 μΩ-cm.

The conductivities (1/resistivity) are reported in S/m (Siemens/meter). The conductivity of the coating is calculated from the whole wire and witness wire measurements of conductivity and respective dimensions. σWire=(ACNTσYCNT+ACuσCu)/(ACNT+ACu) Solving for the conductivity (σYCNT) of the CNT coating, we obtain:

σCNT=(Awireσwire−ACuσCu)/(Awire−ACu)

The areas (A) are determined from measurements of the composite and witness wires.

As described elsewhere herein, comparatively thick aligned CNT coatings may be produced with single or multi-coating approaches. In one illustrative, non-limiting example, a two-coat CNT composite wire was made. An electroplated Cu layer was added between coating processes. The resistivity of the wire and CNT (+Cu) coating were 3.14 and 14.6 μΩ-cm, respectively. Corresponding conductivities were 3.2×10⁷ and 7.0×10⁶ S/m, respectively. The coating thickness was 55 μm thick, comprising 46.5% of the cross-sectional area of the composite wire. Some porosity was present along the interface between the two layers. In one single-coat example, a wire with a coating of 61 microns was found to have wire and coating resistivity values of 3.57 and 71.0 μΩ-cm.

It should be understood that although the present disclosure describes composites that have electronic properties that are superior to those properties of the underlying (i.e., uncoated) substrate. The disclosure also, however, provides for composites that present electronic properties that are equivalent or even lesser than those of the underlying substrates. As one example, a user might begin with a wire substrate having conductivity A and length L. After coating the substrate with CNTs and drawing the substrate, the resultant product may have length L+x and still retain a total conductivity A. In this way, a user may begin with a first quantity of substrate and ultimately obtain a conductor composite that is longer than that first length but still retains the same conductivity characteristics.

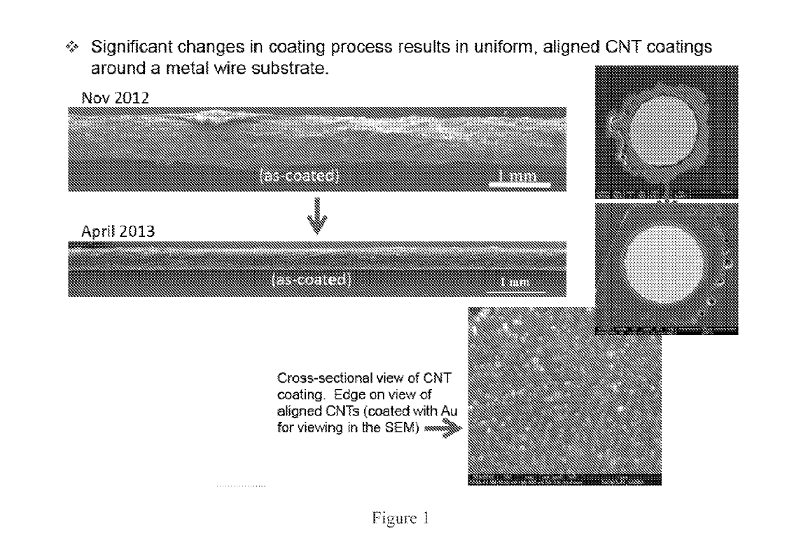

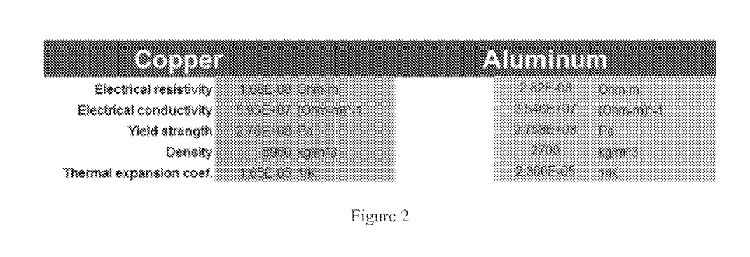

Exemplary FIG. 1 provides illustrations of two CNT-coated wires according to the present disclosure, along with cross-sectional views of those two exemplary wires. As shown in the lowermost image, an edge-on view of the CNTs in the coating shows a plurality of CNTs aligned with the major axis of the substrate. FIG. 2 provides—in table form—electrical and physical characteristics of exemplary Cu and Al metals, which metals may be used as substrates for the composite conductors presented herein.

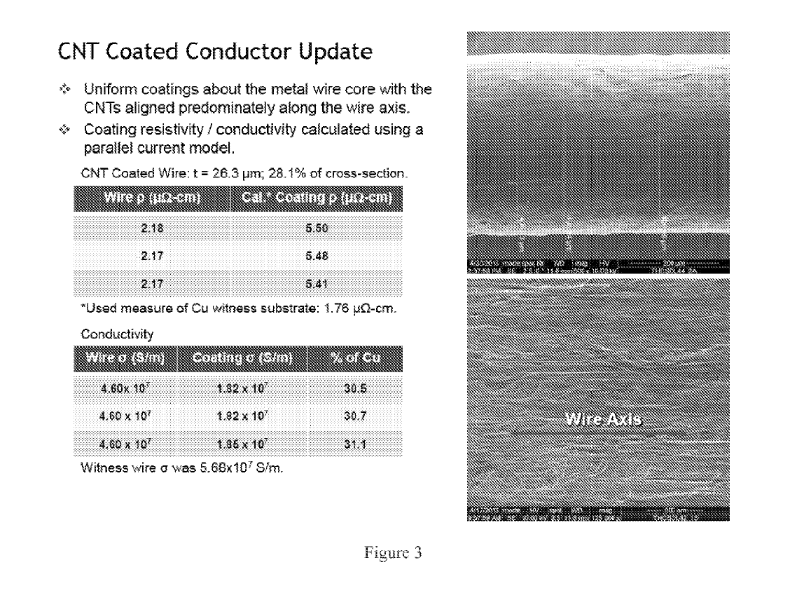

FIG. 3 provides (right-hand images) images of CNT-coated wires according to the present disclosure. As shown in these exemplary images, the diameter of the composite conductor may be in the range of about 400 micrometers. The left-hand side of the figure presents exemplary data for sample CNT-coated Cu wires. The wire resistivity (p) in column 1 of the top table represents the measured resistivity of the whole CNT-coated wire. The resistivity of the CNT coating is calculated using the resistivity of the witness wire which is a piece of the substrate that is not coated with CNTs. The calculation of the coating resistivity is based on current in parallel circuits where total current I or Iₜₒₜₐₗ=I_{Cu core}+I_{CNT coating}. The resistivity data in presented in units of micro-Ohms/cm. The conductivity in the bottom is the inverse of resistivity or 1/p and is presented in the units of S/m (Siemens/meter). The witness wire, which is a piece of the coated substrate wire, provides a measure of the conductivity of the core Cu wire. The conductivity of the CNT composite wire is presented in column 1. The conductivity of the CNT coating is calculated considering a ratio of cross-sectional areas of the Cu core wire and the CNT coating, σwire=(A_{CNTσCNT}+A_{CuσCu})/(A_{CNT}+A_{Cu}) where ACNT+ACU is the total cross sectional area of the CNT wire.

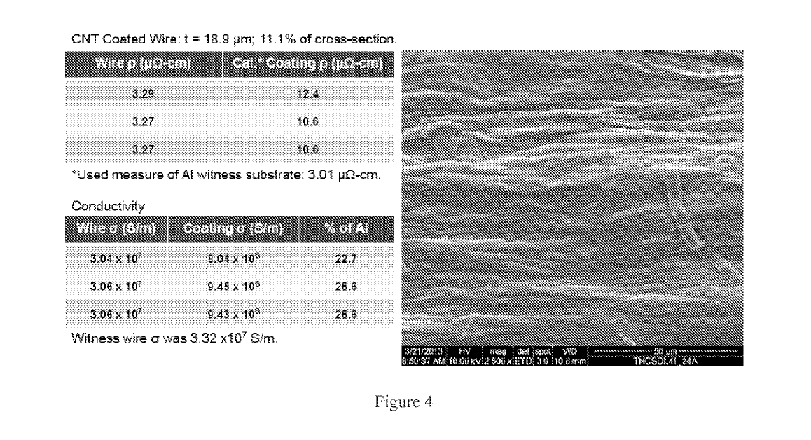

FIG. 4 provides an image of a CNT-coating on an Al wire. The left-hand side of the figure provides exemplary data for CNT-A1 composite conductors, as in FIG. 3.

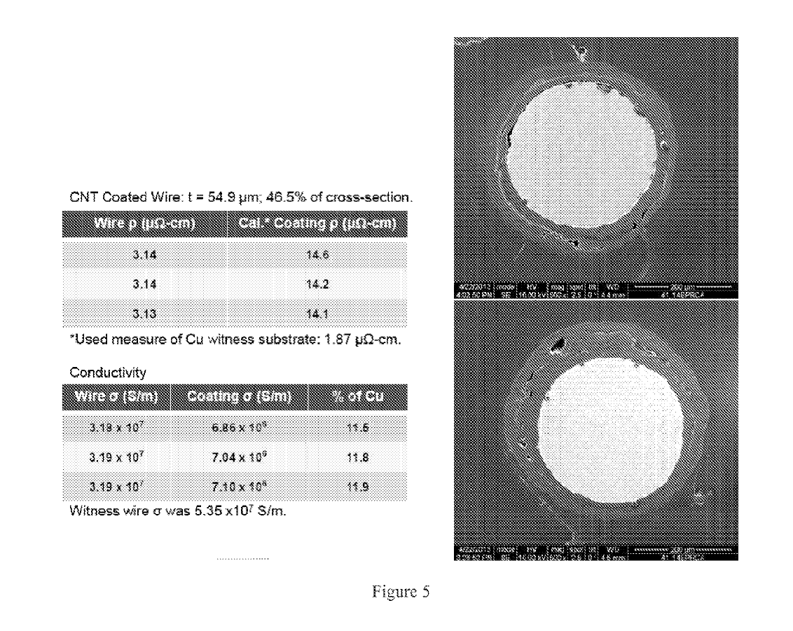

FIG. 5 provides images of CNT-Cu composite conductors in which the Cu substrate is surmounted by two layers of CNTs. Exemplary data are shown in the data tables on the left-hand side of the figure.

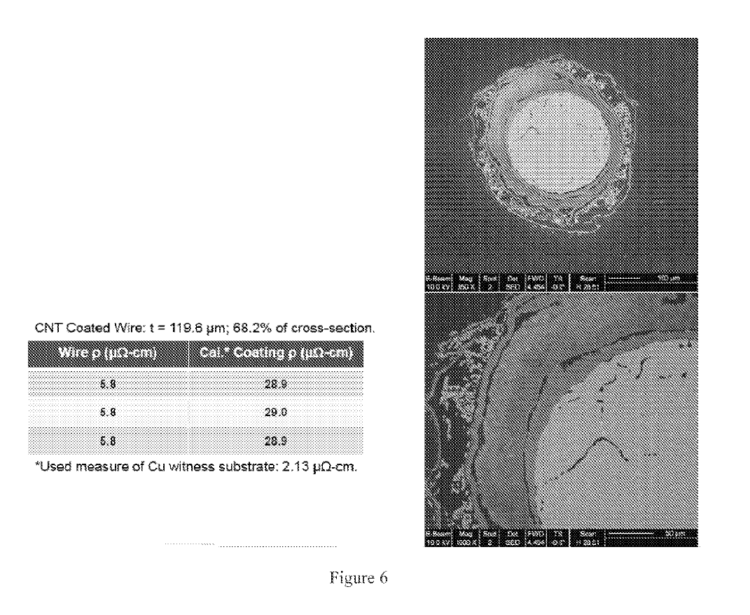

FIG. 6 provides images of CNT-Cu composite conductors in which the Cu substrate is surmounted by two layers of CNTs. Exemplary data are shown in the data tables on the left-hand side of the figure.

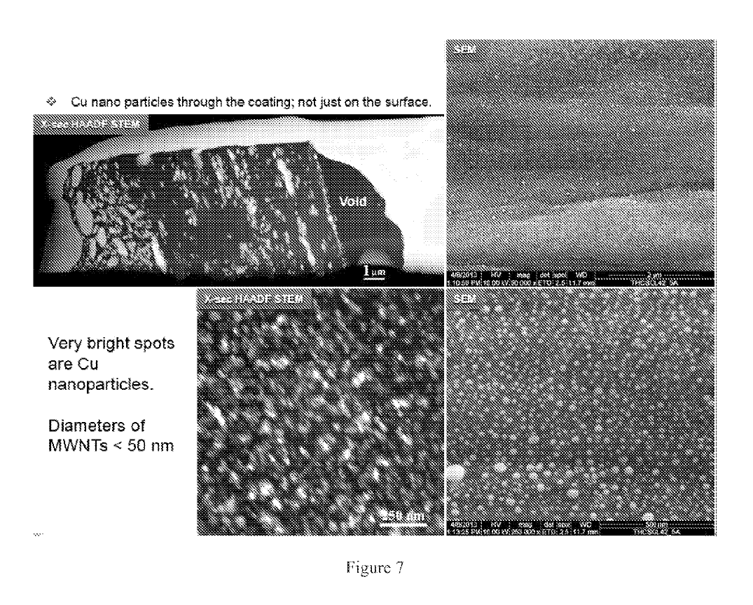

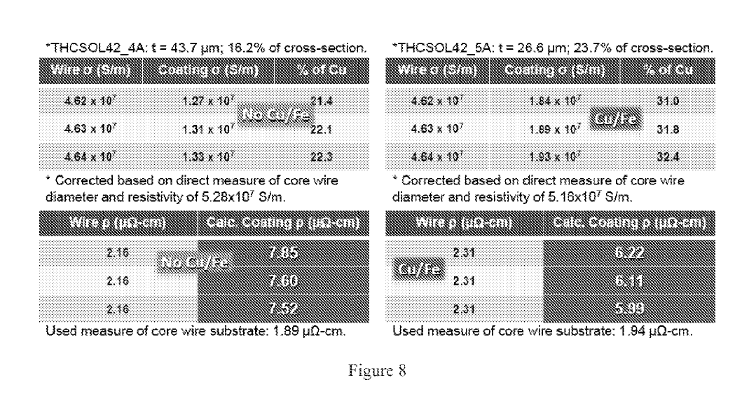

FIG. 7 provides images of CNT-Cu composite conductors in which Cu nanoparticles (less than 50 nm in cross-section) are dispersed in the coating. In these images, the Cu nanoparticles are shown by bright spots. The images show the exemplary conductors at a variety of magnification values. FIG. 8 provides comparative data for composite conductor systems (CNT-substrate) both with and without Cu and/or Fe nanoparticles dispersed within the CNT coating. As shown in the figure, the presence of such nanoparticles improves the electronic properties of the composite conductors. In some embodiments,

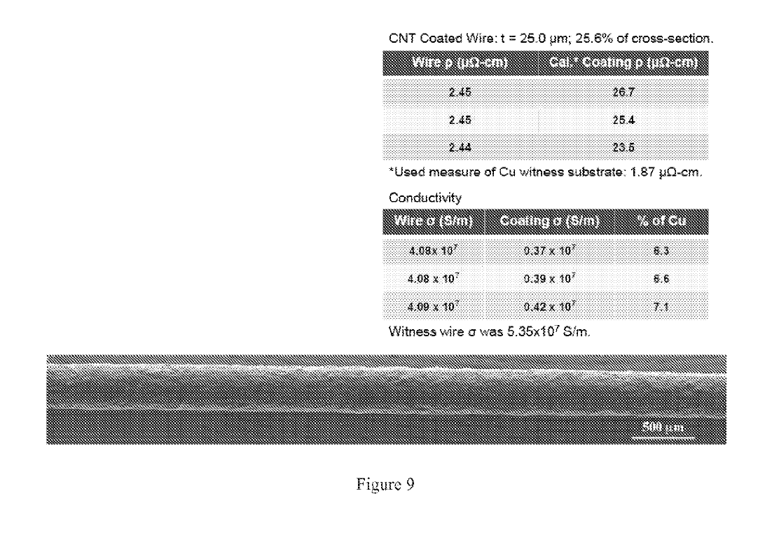

FIG. 9 provides comparative data for composite conductor systems (CNT-substrate) having a CNT coating that includes both explicitly a CNT source powder containing primarily double-wall and a CNT source containing multi-wall CNTs with a majority having more than 2 shells. A mixture of two kinds of CNTs has been shown to help produce more uniform coatings due to the different sizes of the individual CNTs. There has been no observed degradation of properties with multiple kinds of CNTs.

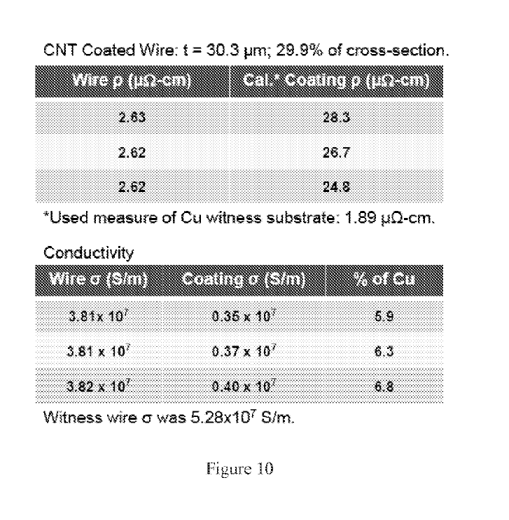

FIG. 10 provides test data for two sets of samples prepared in the same manner. As is seen, materials prepared in a similar manner exhibited similar properties.

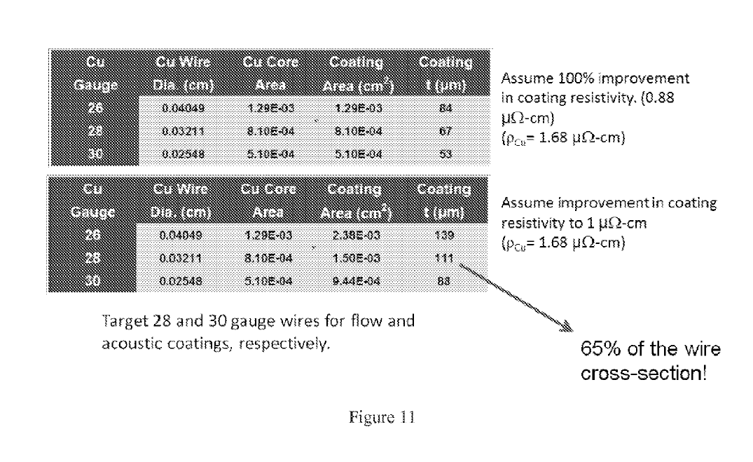

FIG. 11 presents substrate and coating data from exemplary composite conductors. As shown, 28 and 30 gauge wires are considered particularly suitable substrates.

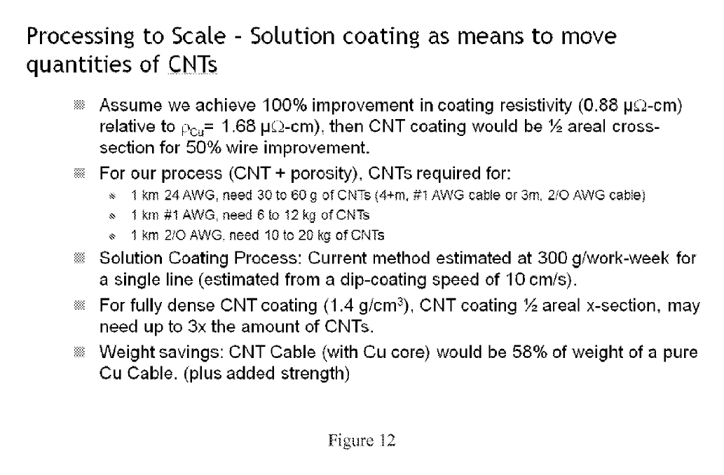

Exemplary solution processing parameters are set forth in FIG. 12. As that figure shows, the CNT coating may be in the range of about 50% of the areal cross-section of the entire CNT composite wire. Without being bound to any particular theory, such a coating thickness may permit a 50% resistivity improvement over the base wire substrate. Because of the improvement in electrical properties, the disclosed composites allow users to achieve—at a reduced weight—the conductivity performance of existing current carriers. The disclosed materials thus have particular use in power transmission applications, as they can provide current carrying equivalent to existing wires, but at lower weight. The disclosed materials also have application in virtually any field that requires electrical power or signal transmission, as they can provide electrical transmission capability at a lower weight than existing materials. Mobile devices or other weight-sensitive applications are particularly well-suited for the disclosed materials. Other applications include space exploration (where launch weight is a particular consideration), armor, large-scale photovoltaics, and telecommunication lines. It should be understood that the coating may, in some cases, have a conductivity that is lower than that of the substrate.

A solution may be pure water, but may also include a surfactant and an acid, as described elsewhere herein. A solution may include a mix of CNT fibers and individual CNTs, fibers across different length scales, and even loose fibers in solution that exceed several cm in length. The user may use CNT fibers in solution to aid in the alignment of the CNTs onto the wire former. A CNT fiber may have a length that is 2× to 1OO× times length of individual CNTs. Suitable surfactants include, e.g., Triton-X, SDA, Dawn™ detergent, and the like. CNTs may be present at, e.g., from about 1 to 3 ml/10 mg in solution. A user may use CNTs of various length scales to form aligned fibers. Some commercial CNTs are comparatively short, on the order of tens of microns. A user may use long CNTs (e.g., MWNTs) on the order of mm's in length to form backbones as templates for ordering the shorter nanotubes into aligned fibers.

One illustrative example used CNTs grown as a forest array. The CNTs were lifted off of substrate and put into stirring apparatus (tines for pulling apart forests). The CNT dispersion solution was H2O with 10% isopropanol, although the isopropanol is not mandatory. Dawn™ detergent was used as the dispersant (3.5 ml/10 mg CNTs), and the mixture was stirred for approximately 4 hours. CNTs (26.5 mg) plus Dawn™ in 50 ml of the solution.

The mixture was placed in a larger beaker, and more solution (H2O with 10% IPA) was added to bring solution total to 400 ml. The solution was stirred at a high rate of speed (stir plate set to 1200 rpm). For coating, Cu wires (which may be abraded or otherwise roughened) were dipped into the solution, held for 10 sec, and drawn out at a speed of about 10 cm/sec. Coatings made with water based solutions tended to be very thick after just one dip. To increase coating uniformity, a second dip could be applied were the opposite end was dipped into the solution first (reverse coat).

A user may use an acid-containing solution. Such solutions are considered particularly suitable for individual CNTs and short CNT fibers (<1 cm), likely on order of a couple mm. One may use of CNT fibers in solution to aid in the alignment of the CNTs onto the wire former, with CNT fibers of length 2× to 100× times length of individual CNTs. Sulfuric acid is considered especially suitable; in one example, a user may use 250 ml solution with CNTs 10 to 40 mg. demonstrated. It is considered suitable to have sufficient liquid to wet CNTs and to create flow conditions in the reactor relative to wire substrate.

One may also use a mixed acid/water-based solution. A user may use shear stirring in acid to break up clumps of CNTs and form a uniform mixture of fibers and individual CNTs in solution. One may mix in water and/or dispersant to form extended fibers for use in the deposition/alignment process. This is considered a hybrid process to control the formation of CNT fibers in solution.

In some embodiments, a user may wish to use an organic solvent and water to remove surfactants. Some suitable solvents include alcohols (e.g., methanol, isopropanol, ethanol), and the like. In some embodiments, the user may performed a water rinse, which rinse may give rise to a smooth, dense coating. Without being bound to any single theory, the presence of water in the coating allowed for better wire deformation in final shaping processes; CNT adhere better to substrate; and CNT deform in a more defined manner. Water may help in removing sulfuric acid, (other acids as used in the acid process) and also to define fibers prior to removing from solution and drying. After beginning with a water or water/acid based solution; it may be useful to dip in acid (sulfuric) prior to final rinse in water, which may limit CNTs from falling off in the water rinse.

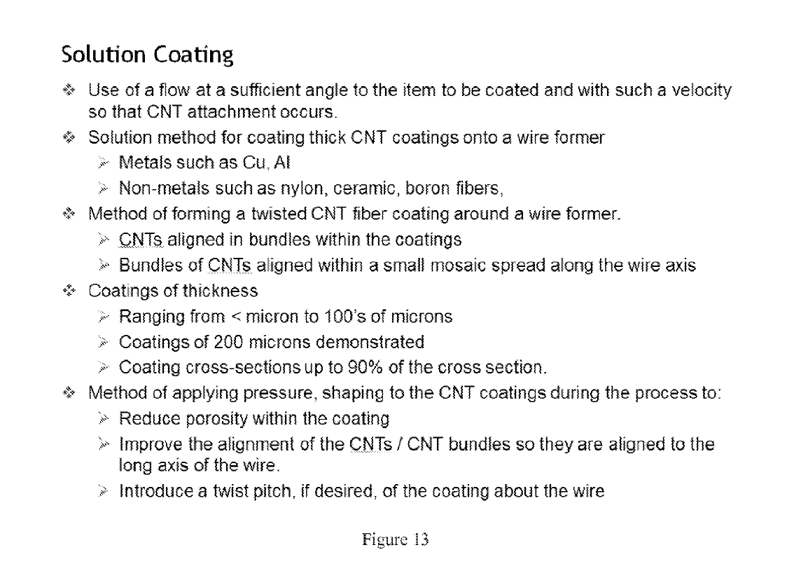

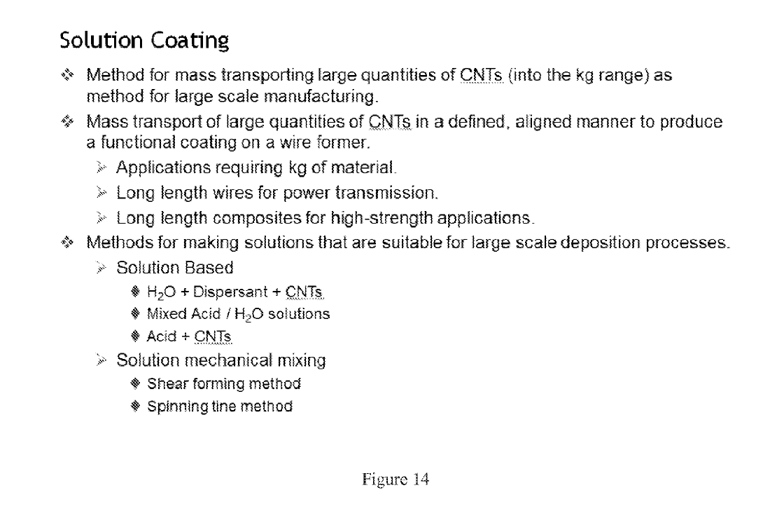

Sample solution coating considerations and parameters are shown in FIG. 13. As that figure explains, a variety of substrates may be used in the disclosed composite structures. The CNTs may also be contacted to the substrate under flow conditions so as to give rise to attachment between the CNTs and the substrate. As explained in FIG. 14, the disclosed methods may be used in large-scale production processes, and are especially well-suited to processes that produce composite materials of substantial length.

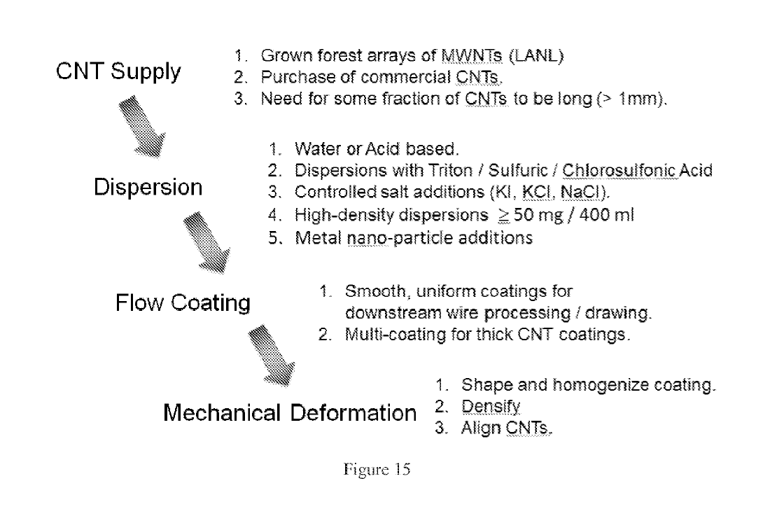

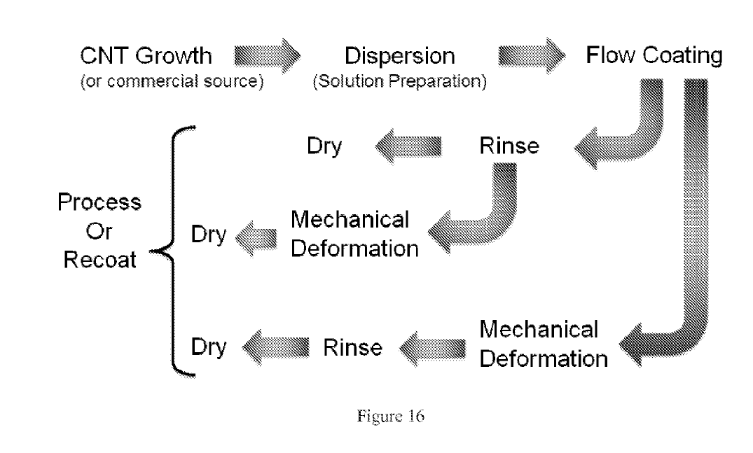

One exemplary production process is shown in FIG. 15. As explained in the figure, a user may begin with a supply of CNTs, which CNTs may be purchased or grown by the user. The user then suitably disperses the CNTs in a fluid. Dispersion fluids may be aqueous in nature, and may suitably include acid to assist with dispersing the CNTs. The fluid may also include a salt, a surfactant (e.g., Triton™, Dawn™, and the like). Metallic nanoparticles may also be disposed in the fluid. The CNTs may then be applied—e.g., under flow and/or stirring—to the substrate. The substrate may be immersed in the fluid. The coating may be applied in a single step or in multiple steps Following coating application, the coating may be densified (e.g., by drying), and the coated substrate may be drawn or otherwise deformed. The drawing may serve to align the CNTs of the coating. It should be understood that nanoparticles (and/or metallic salts) may be applied after the CNTs are applied to the substrate. A further overview of an exemplary process is shown in FIG. 16, which figure shows the various steps of a fabrication process for the disclosed composites.

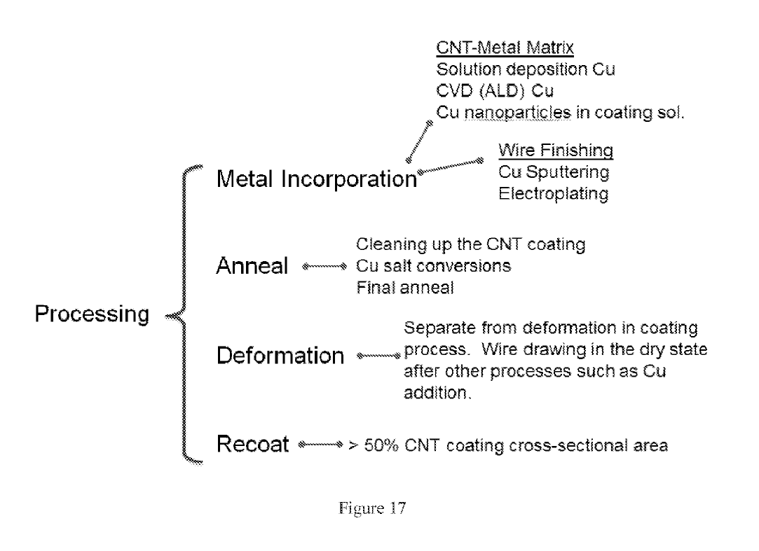

FIG. 17 provides an overview of the various processing steps that a user might apply to the disclosed materials. For example, a user may incorporate metal into the CNT coating and anneal the resulting product. The user may also deform—e.g., via drawing—the resultant composite materials.

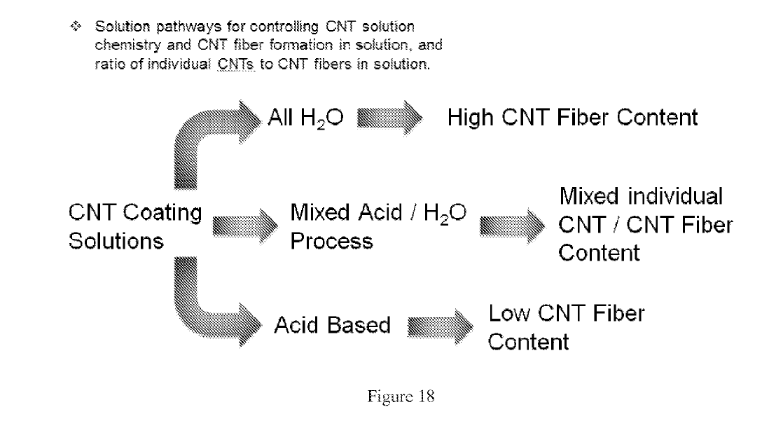

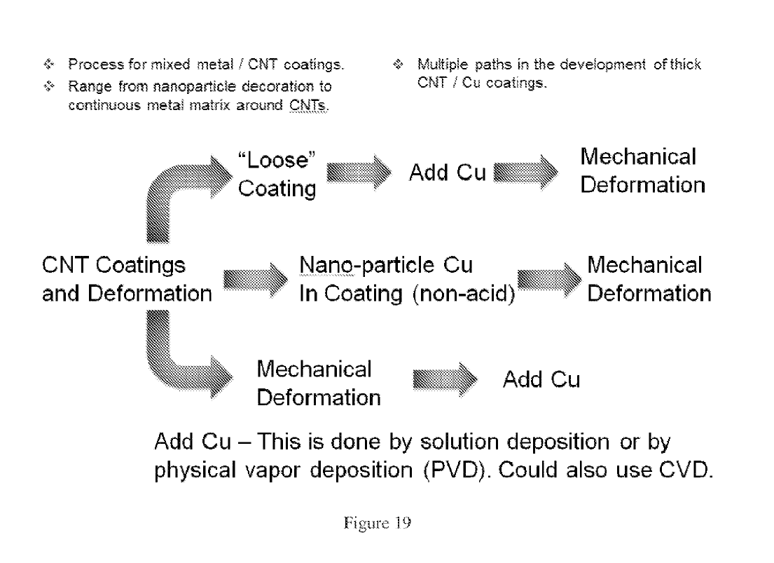

FIG. 18 provides an overview of various solution (fluid) pathways for tailoring CNT solution chemistry and CNT fiber formation. As shown, varying the acid content of the fluid may affect the proportion of CNT fibers in the solution. FIG. 19 provides an overview of various pathways to introduce particulates—e.g., metal—into the coatings of the disclosed composite conductors. As shown, metal may be added at one or more stages of the fabrication process.

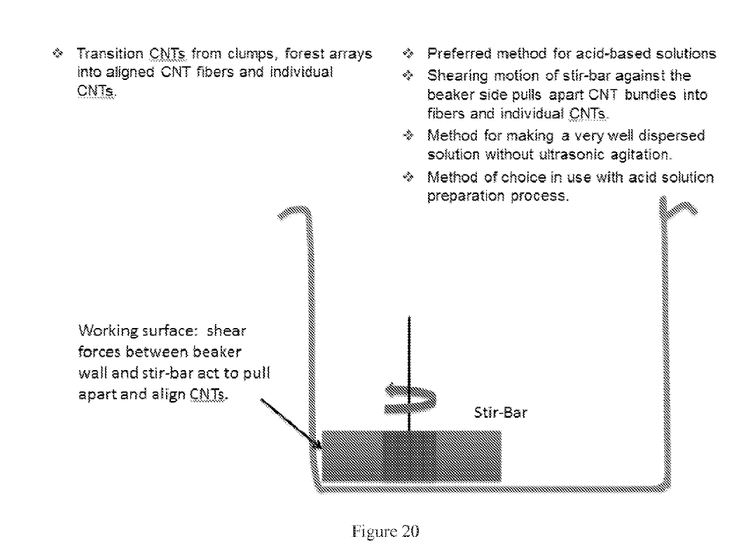

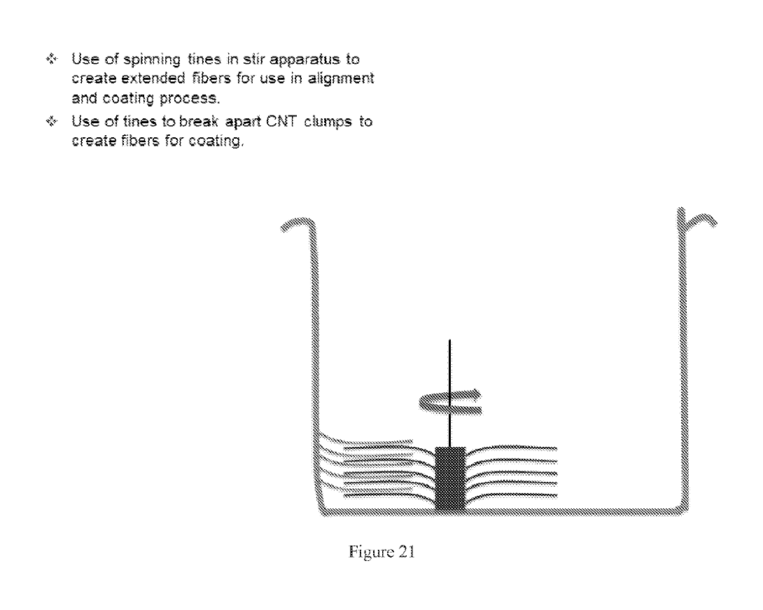

FIGS. 20 and 21 provide depictions of stirring—with and without tines—the CNT-containing fluid so as to align CNTs disposed within the fluid and to align the CNTs. Stirring may be accomplished by a stir bar, by a stirrer, or by other stirring methods known to those of ordinary skill in the art. CNTs may also be flowed within a container, as CNT motion need not necessarily be achieved by stirring. Mechanical and ultrasonic agitation may be used to disperse CNTs in a fluid. Salts, charge adjustment, and other methods may also be used to disperse CNTs in solution.

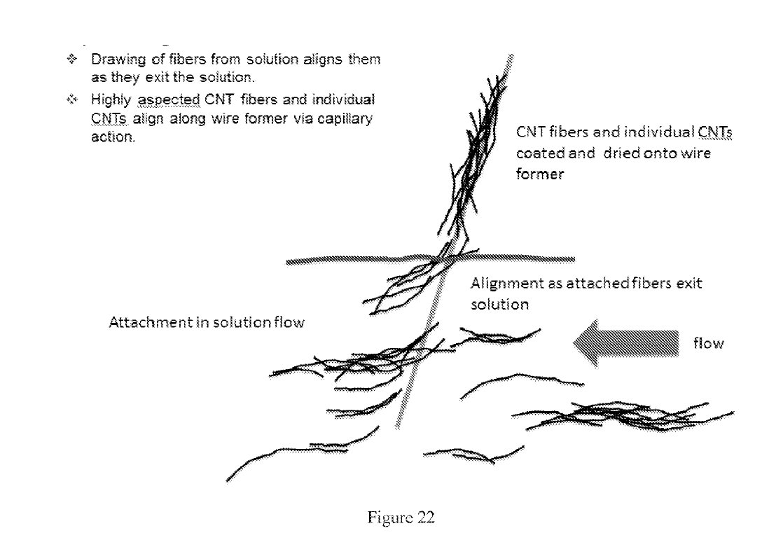

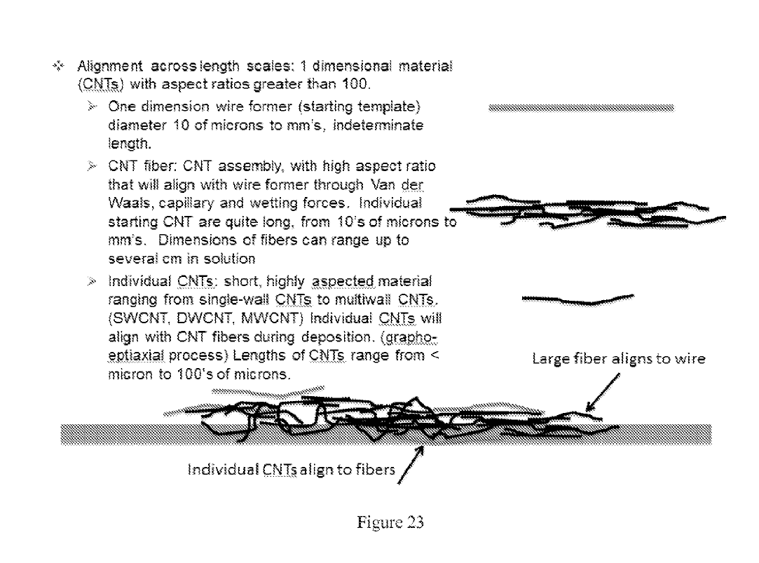

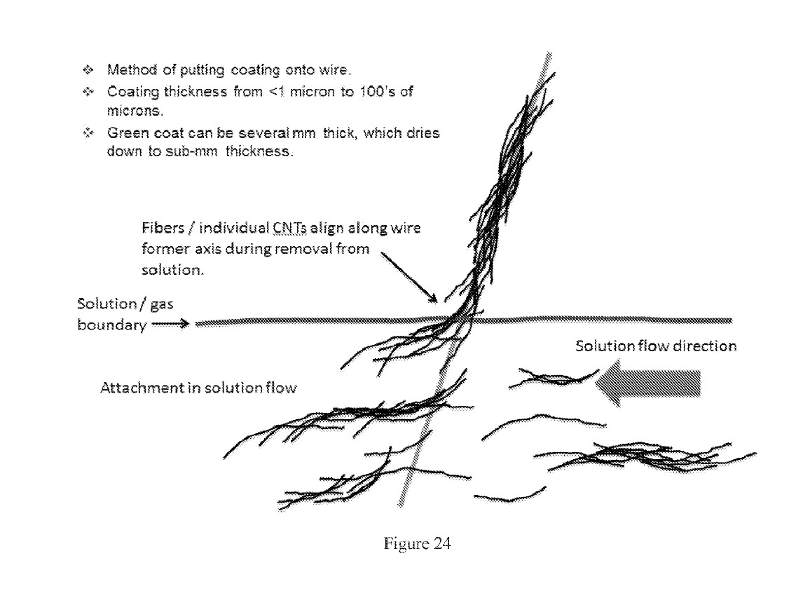

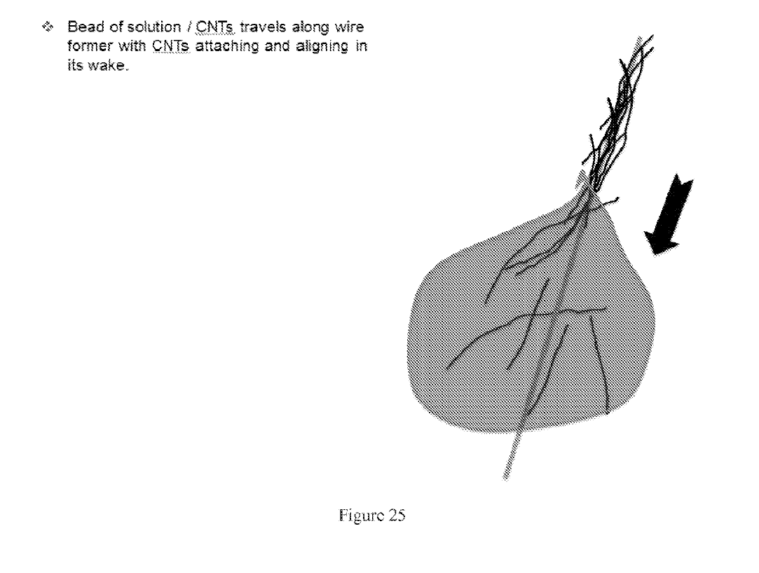

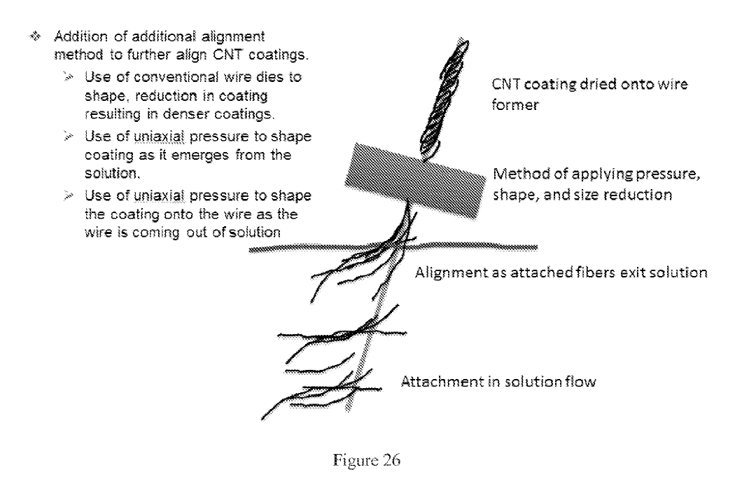

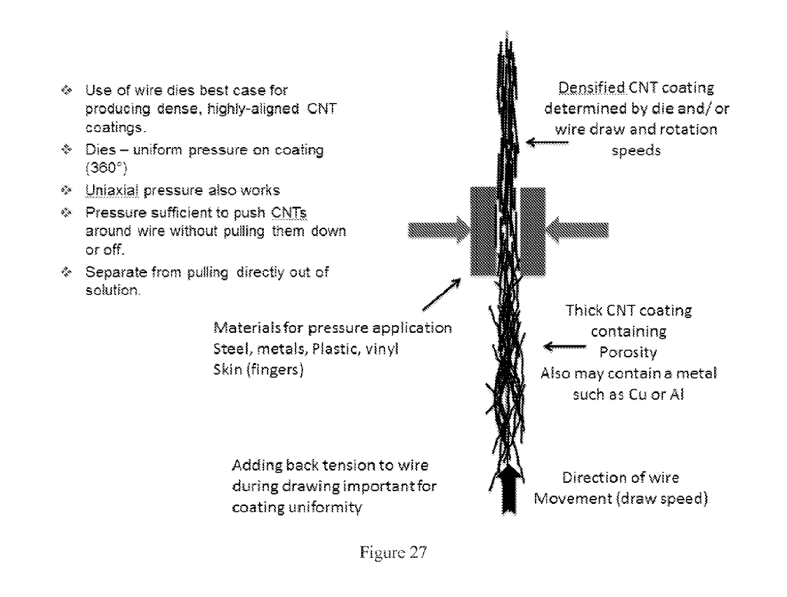

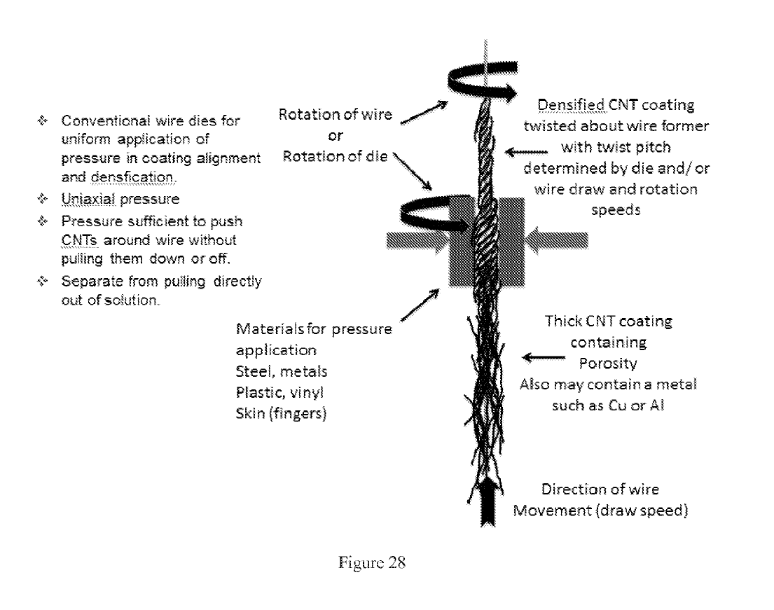

FIGS. 22-28 depict various methods of aligning CNTs on a substrate. FIG. 22 depicts alignment of flowing CNTs on the substrate as the substrate is withdrawn from the CNT-containing solution. FIG. 23 depicts the alignment of CNTs across length scales, showing the alignment of CNT fibers to the wire substrate and the alignment of individual CNTs to the CNT fibers. FIG. 24 depicts deposition of CNTs onto a wire without initial deformation. As explained in the figure, the so-called “green coat” of CNTs that is deposited onto the wire substrate may be dried and densified to a thickness less than the initial “green coat” thickness. An alternative deposition technique is shown in FIG. 25, which figure shows a CNT-containing bead of solution traveling along a wire substrate. CNTs contained in the fluid attach to the substrate and align as the bead travels along the substrate. The use of a conventional wire die is shown in FIG. 26, which figure shows application of pressure, shape, and/or size reduction to CNTs and a substrate so as to give rise to a CNT-coated substrate with aligned CNTs. An exemplary die drawing process is shown in FIG. 27. Drawing with a twist motion is shown in FIG. 28. Twisting may be performed before, during, or even after drawing. The optimal twist rate will depend on the user's needs.

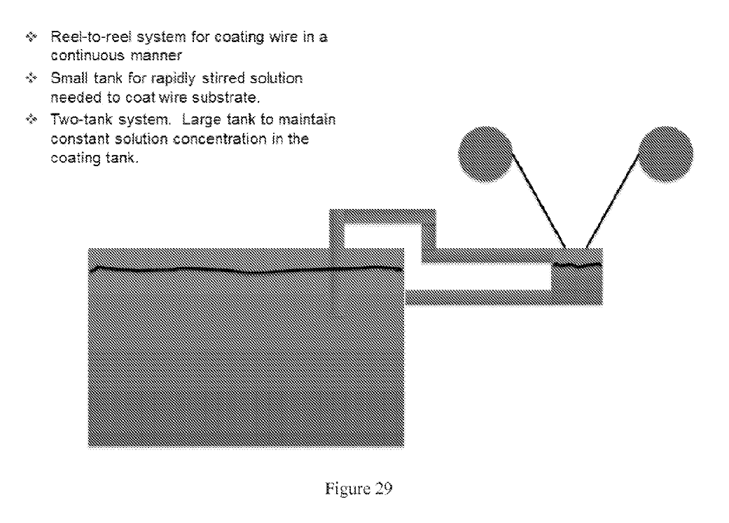

An apparatus for producing the disclosed composites at scale is depicted in FIG. 29. As shown in that figure, a first (large) tank contains CNTs dispersed in an appropriate solution. The substrates are immersed into the smaller tank, which immersion may be performed in a reel-to-reel manner.

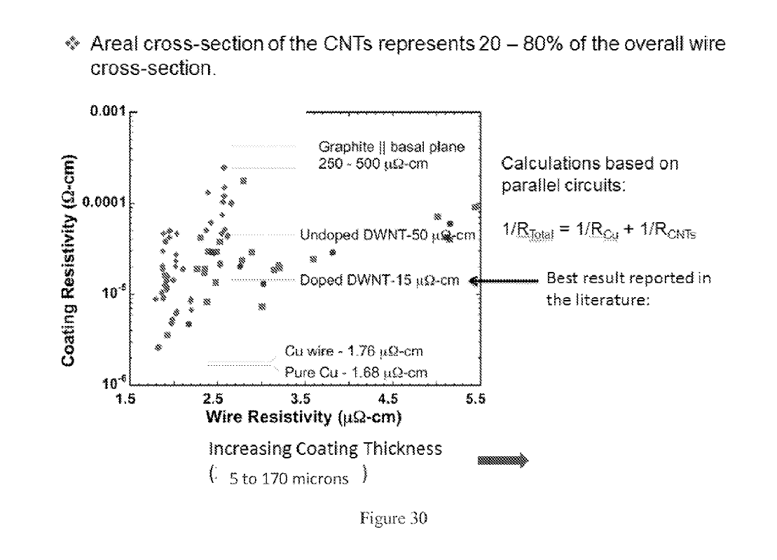

FIG. 30 presents exemplary data from illustrative embodiments of the disclosed composite structures. The calculated CNT coating resisitivity is plotted against the overall CNT composite wire resistivity. The plot gives a measure of the wide range of coating resistivities that can be found in these wires that are sensitive to processing conditions and any current limiting mechanisms contained within the coatings. This set of data covers coating thicknesses ranging from 5 to 170 microns. The data points that are associated with the higher overall wire resistivities (x-axis) were typically correlated to very thick coatings on the wire substrates.

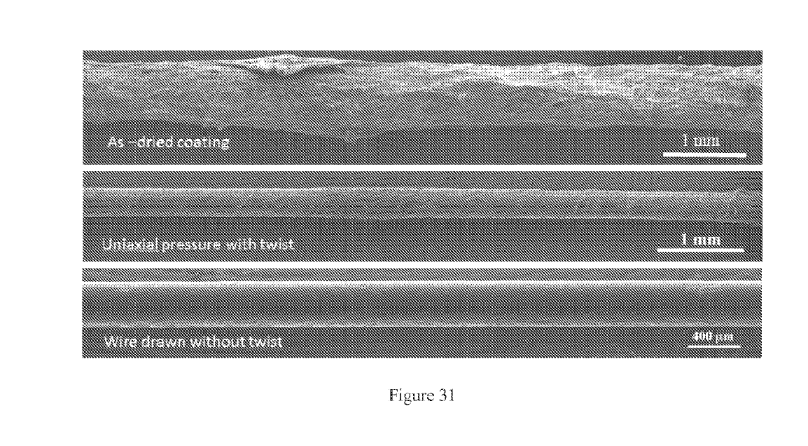

FIG. 31 illustrates the effect of uniaxial drawing with and without twist. The top image in the figure illustrates an as-dried CNT coating on Cu wire substrate. The middle panel illustrates a CNT-coated Cu wire that has undergone a uniaxial pressure draw with a twist. The lower panel illustrates a CNT-coated Cu wire that has a uniaxial pressure draw without a twist.

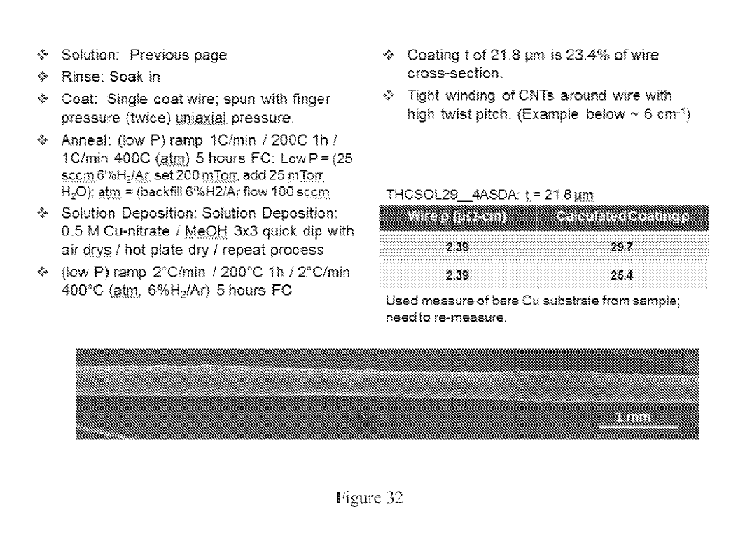

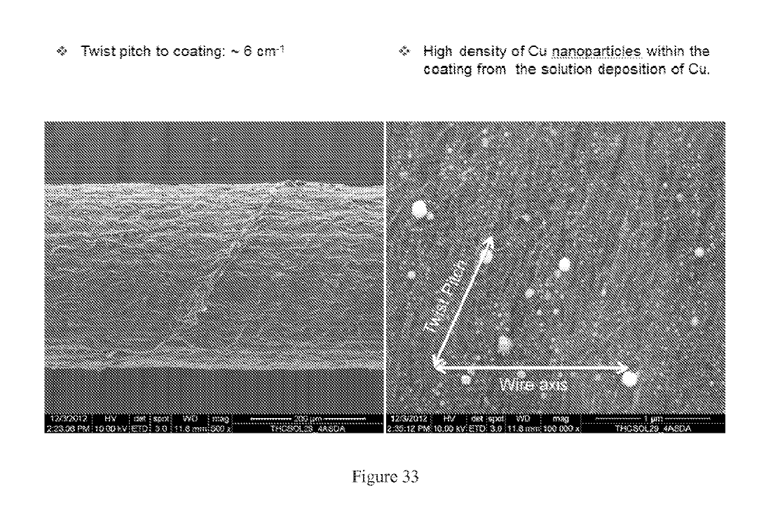

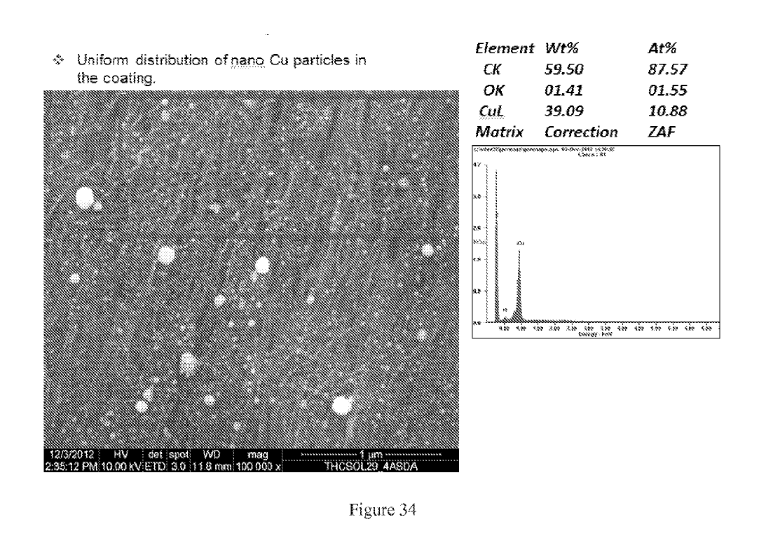

FIG. 32 provides an image of a CNT-coated wire formed from a water based surfactant solution. The figure also provides exemplary processing conditions for producing the disclosed composite. FIG. 33 provides additional images of composites (formed via drawing with twist) from a water based surfactant solution. FIG. 34 provides a magnified view and elemental analysis of the composite shown in FIG. 33.

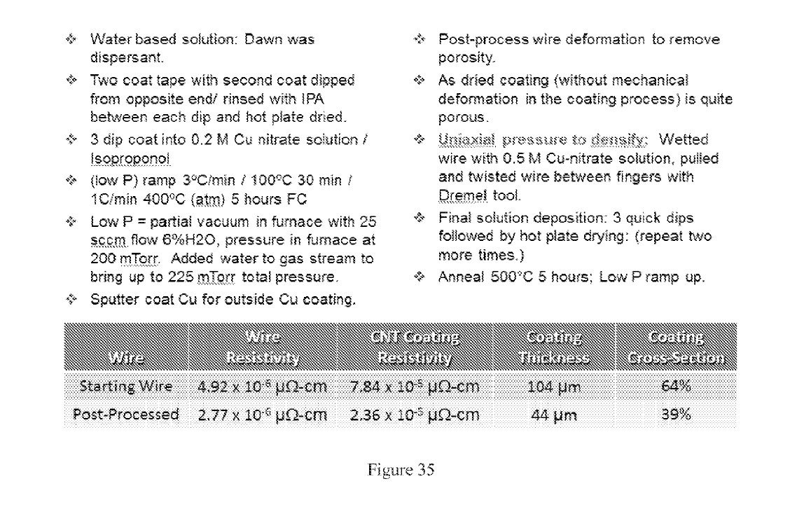

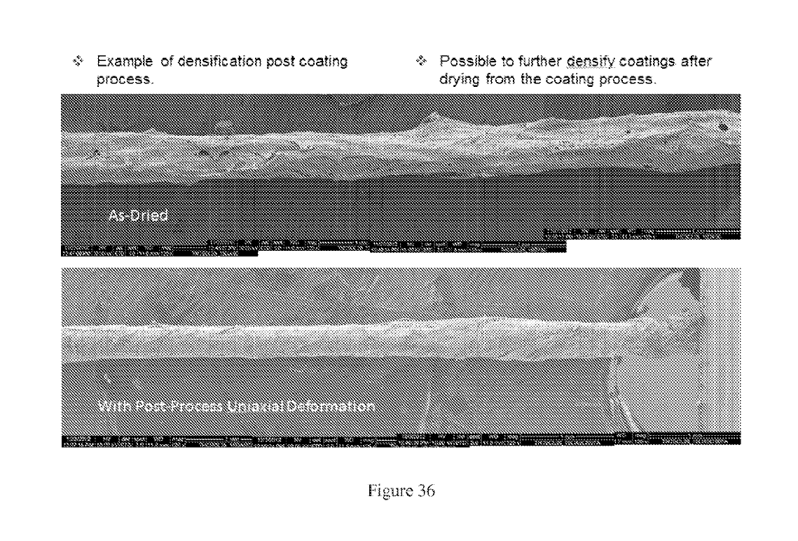

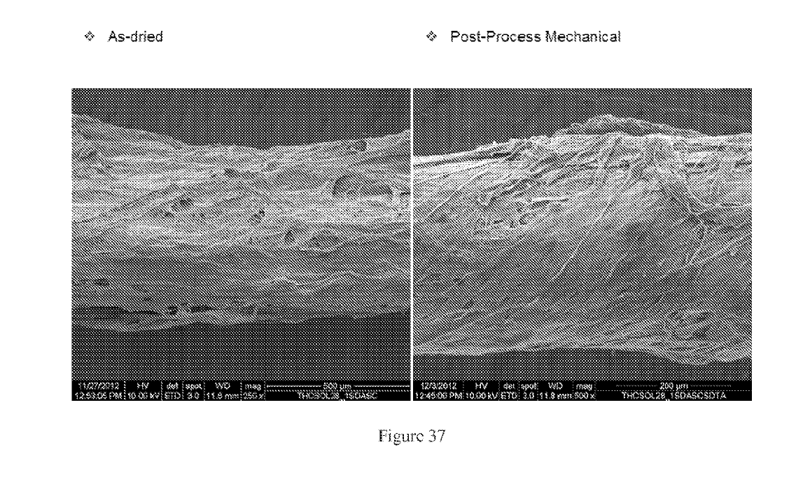

FIG. 35 provides exemplary processing conditions for post-processing with wire deformation. As shown at the bottom of the figure, the post-processed wire exhibited improved properties over the starting wire material. FIG. 36 provides illustrations of densified, post-coating processes. FIG. 37 provides images of post-processed composites with wire deformation.

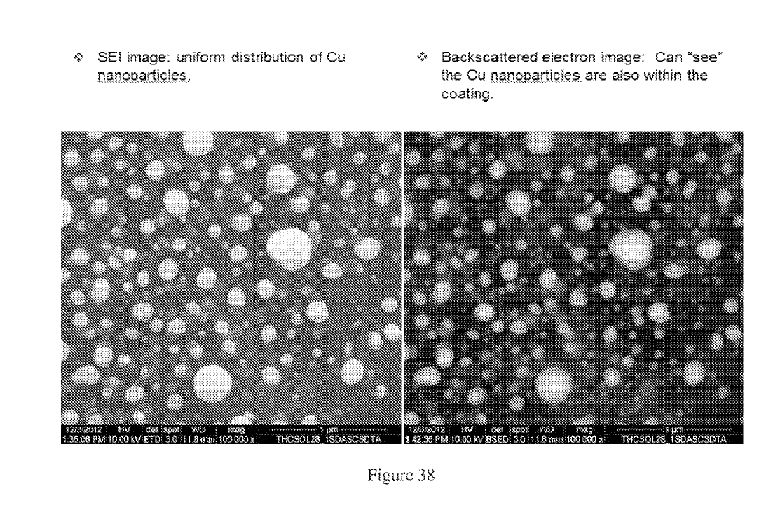

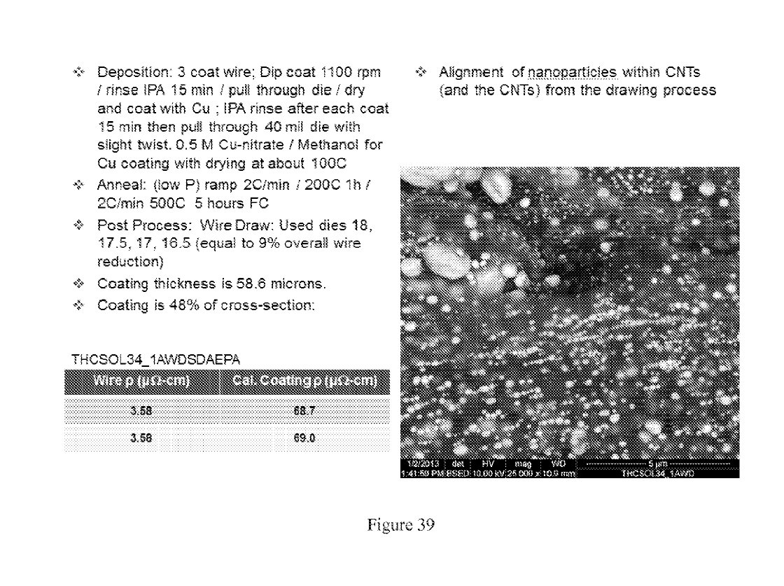

Illustrations of nanoparticles within the CNT coatings are shown in FIG. 38. As shown in that figure, the Cu nanoparticles are dispersed within the CNT coating. FIG. 39 provides an illustration of a post-processed CNT-coated wire with Cu nanoparticles disposed within the CNT coating.

Further exemplary embodiments follow; these are illustrative only and do not necessarily limit the scope of the present disclosure. In one mixed solution embodiment, 17.5 mg CNTs were added to 20 ml H2SO4 and shear-stirred for 2 hours. This solution was poured into a spinning tine stir apparatus that contained 120 ml H2O. Immediately formed extended fibers and clumps (coagulates) in solution. Triton X (commercial dispersant) at 1.75 ml/10 mg CNTs was added and stirred with a spinning tine apparatus to homogenize fibers and break up clumps and form uniform fibers. The material was placed in a 1 L beaker and then enough H2O was added to make a 900 ml solution. Dip coat at high speeds, 700 and 1100 rpms, and a Cu coating was electroplated around the wire substrate. Annealing was performed at R 1C/min 250 C 2 hr R2C/min 500 C 10 hrs 6% H2/Ar Furnace F4 SM32. Results are presented in the tables below:

| | |
|---|---|
| 4.68 | 107.7 |
| 4.69 | 111.4 |

34.6 μm coating; 33.1% of cross-section.

| | |
|---|---|
| 2.75 | 20.3 |
| 2.75 | 20.2 |

Additional data are shown in the table below:

| | Average | | | | | | |
|---|---|---|---|---|---|---|---|
| | Coating | CNT Arcal | Wire | CNT Coating | Wire | CNT Coating | CNT Coating |
| Wire | Thickness (μm) | Cross-Section | Resistivity (μW-cm) | Resistivity (μW-cm) | Conductivity (S/m) | Conductivity (S/m) | Percent of Copper |
| 46_14 | 23.1 | 34.2% | 2.47 | 14.9 | 4.19 ± 10⁷ | 4.19 ± 10⁶ | 11% |
| 46_15 | 18.2 | 19.3% | 3.78 | 15 | 4.19 ± 10⁷ | 4.19 ± 10⁶ | 12% |
| 45_1 | 25 | 25.6% | 2.45 | 25.2 | 3.93 ± 10⁷ | 1.08 ± 10⁶ | 7% |
| 45_2 | 30.3 | 20.6% | 2.62 | 39.3 | 3.83 ± 10⁷ | 3.77 ± 10⁵ | 7% |
| 44_4A | 63.9 | 43.7% | 4.03 | 16.6 | 2.48 ± 10⁷ | 1.01 ± 10¹ | 18% |
| 43_5 | 50.2 | 43.0% | 3.13 | 9.6 | 3.20 ± 10⁷ | 2.71 ± 10⁶ | 5% |
| 42_15A | 26.3 | 28.1% | 2.17 | 35.6 | 4.60 ± 10⁷ | 3.21 ± 10⁷ | 11% |
| 42_17 | 18.3 | 20.0% | 2.22 | 15.1 | 4.20 ± 10⁷ | 6.10 ± 10⁶ | 11% |
| 42_7A | 12 | 10.9% | 2.03 | 12.4 | 4.21 ± 10⁷ | 6.18 ± 10⁶ | 14% |
| 42_5A | 26.6 | 23.7% | 2.31 | 6.1 | 4.83 ± 10⁷ | 3.22 ± 10⁷ | 12% |
| 41_14A | 34.9 | 46.5% | 3.14 | 14.3 | 2.19 ± 10⁷ | 3.10 ± 10⁶ | 12% |
| 39_5 | 119.6 | 68.2% | 5.8 | 23.9 | 3.32 ± 10⁷ | 4.43 ± 10⁶ | 6% |

In one illustrative embodiment, a H2O water based solution was formed, using 3.5 ml Dawn™/mg CNTs. Mixing started with spinning tines (stir apparatus) CNTs plus Dawn™ plus solution (10% by volume Isopropanol in H2O). Total 60 ml. Stirred for 4 hours. The mixture was then added to a new beaker (without tines, regular stir bar) and brought to 400 ml (10% by volume isopropanol in H2O). Wire substrates were coated with this solution. The steps of coat/hot plate dry/coat/hot plate dry (without mechanical deformation to densify coatings, at this point) were then performed.

A solution was modified to make a 0.2 M Cu-salt (adding Cu(N03)2*2.5 H2O) solution. Then the samples were coated again with this modified CNT solution. Other Cu, Mg, Ti, and Fe salts used successfully, including CuSO4, CuC12*2H2O, Cu(N03)2*3H2O, Mg(N03)2*XH2O, Fe(N03)3*9H2O, and TiCl3

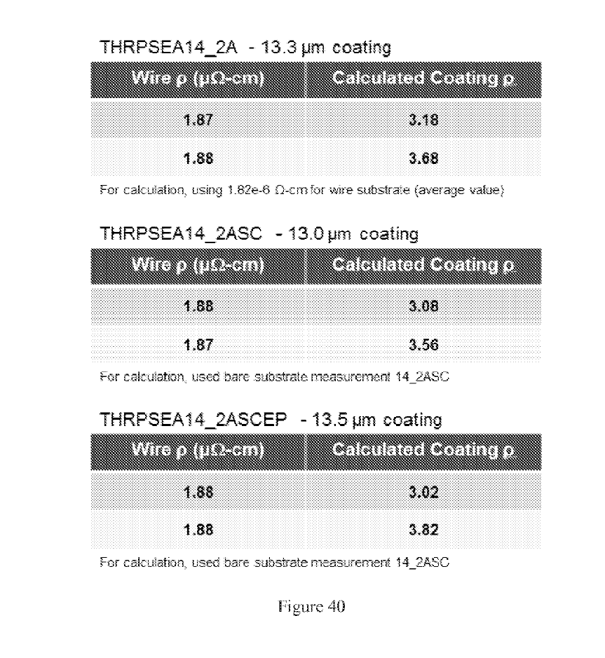

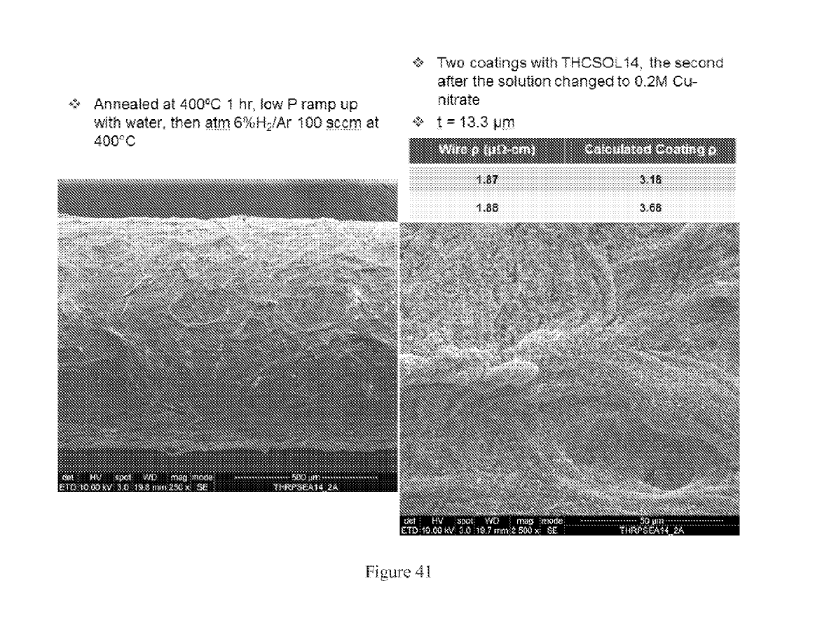

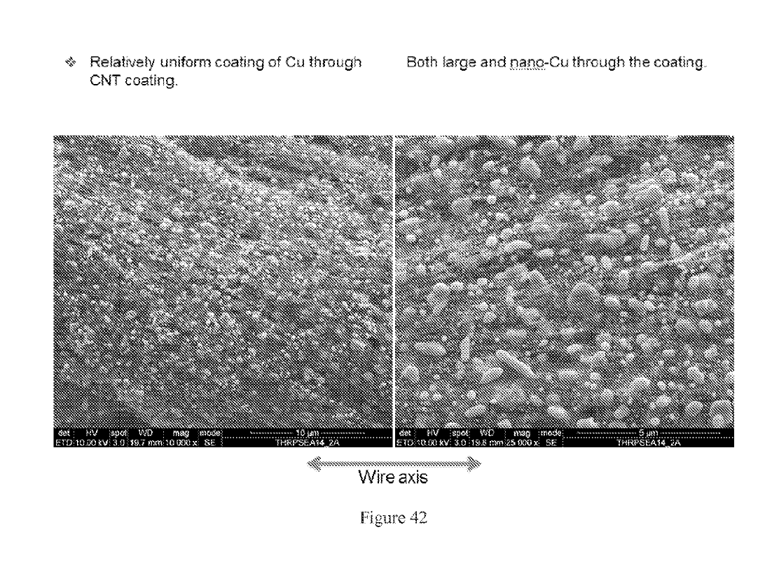

With particular reference to FIG. 40, shown are two coatings with original CNT solution, plus one coating with the modified solution (0.2 M Cu-nitrate). The result was annealed at 400° C. 1 hr, arm 6% H2/Ar 100 seem, with a low P ramp up with H2O, with a low P-partial vacuum, 25 seem flow 6% H2/Ar at 200 mTorr, and by adding 25 mTorr water vapor. Total pressure was 225 mTorr during low-P anneal. A sputter coat was applied; the sputter coat was about 1000 A, with electroplating and a comparatively long anneal at 400° C. 15 hours, 6% H2/Ar. FIG. 41 shows an additionally magnified view of the samples of FIG. 40. FIG. 42 shows the relatively uniform presence of Cu throughout the CNT coating, showing the presence of Cu particles of variable sizes.

In another illustrative example, two small batches of CNTs of about 40 mg MWNTs in 75 ml of H2SO4 (fuming, 12M) were formed. The samples were shear-stirred for 2.5 hours, and the solutions were added together in a larger beaker and added more H2SO4 to bring 400 ml of solution. The total mixture was stirred at 1200 rpm on a stir plate to homogenize solution and then dip coated at a 1200 RPM solution stir rate. The material was dipped at 1200 RPM and removed at 10 cm per sec, and was rinsed and dipper in H2O; repeat 3 more times. A green coat of about 1 to 2 mm in thickness was observed, and the materials were rinsed and soaked in water for 15 minutes. Wire deformation was then performed in the wet state. It should be understood that wire deformation may be performed with a wet or dried coating.

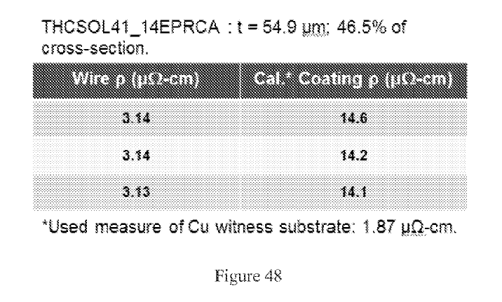

With reference to FIG. 48, shown are data from products made using an all-acid solution. CNTs were mixed with a stir bar (shear stirring) into 80 ml H2SO4 in 100 ml beaker; dispersed in 3 hrs. The solution volume was increased to 160 ml in a larger beaker with round stir bar after just 3 hours. Next, 52.5 mg DWNT (2:1 commercial to lab-made MWNTs) were added.

At 1100 RPM stirring, a double coat of CNTs was applied, with the following steps: First coat was a 3× (dip/H2O dip) rinse H2O 15 minutes/draw 40, 35, 30, 25 mil dies; initial and final rinse H2O/rinse IPA 10 min and then acetone 10 min/hot plate dry: 2nd coat, reverse coat; 3× (dip/H2O dip) rinse H₂O/draw 40, 35, 30, 25, mil dies; initial and final rinse H2O/final rinse acetone/hot plate dry;

Electroplated Cu was then coated onto the wire. The target was a 5 micron coating, followed by a CNT recoat after electroplating.

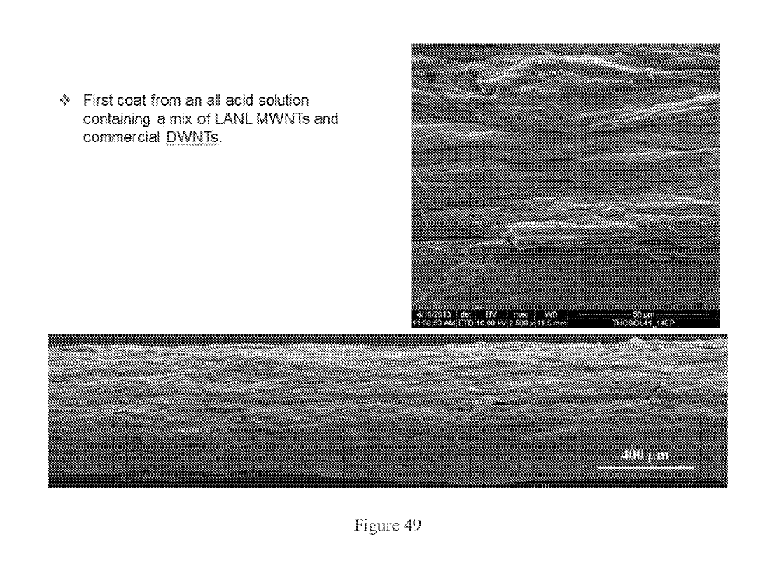

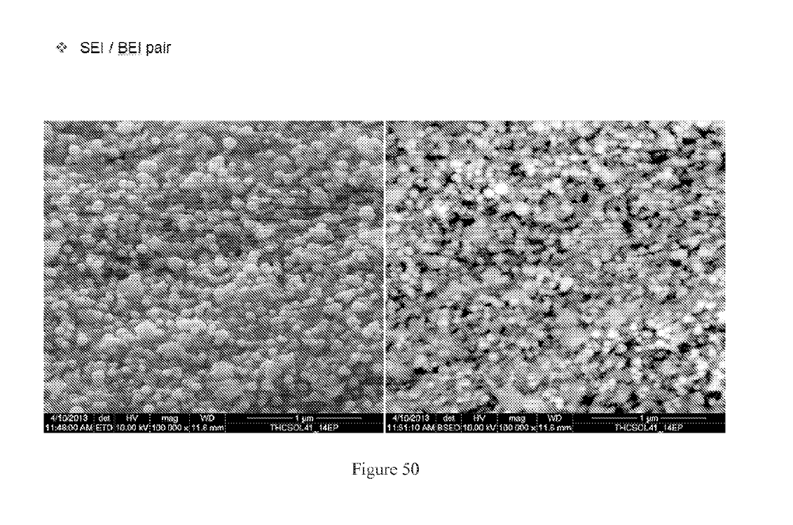

A 1200 rpm single coat was performed, with additional steps: 3× (dip/H2O dip) 15 min rinse in distilled H2O; Wire draw with 40, 35, 30, 25, 23, 20.1, 19, 18, and 17 mil dies and then hot plate dry. The materials were then annealed at 550 C Ar 250 seem+−5 C/min ramp/cool Furnace F4 Basement SM34. The resultant products are shown in FIGS. 49 and 50, discussed elsewhere herein, with data shown in FIG. 48.

In another illustrative embodiment, an acidic solution was used, with the following steps: mixed 25 to 30 mg of lab-made MWNTs in 75 ml of H2SO4, (two batches); Shear-stirred about 1½ hours. Mixed 295 mg commercial single wall nanotubes (SWNTs) in 75 ml H2SO4, Stirred for about 24 hours. Added all three solutions to another 125 ml H2SO4 (400 ml total now) in 400 ml beaker.

A 5:1 mix SWNTs to MWNTs was used; stirred total mixture briefly at high speed for 10 min. Let solution age for three days. Stirred at high speed (1200 rpm) for 1 hour just before first depositions, to thoroughly mix/homogenize all the liquid and nanotubes.

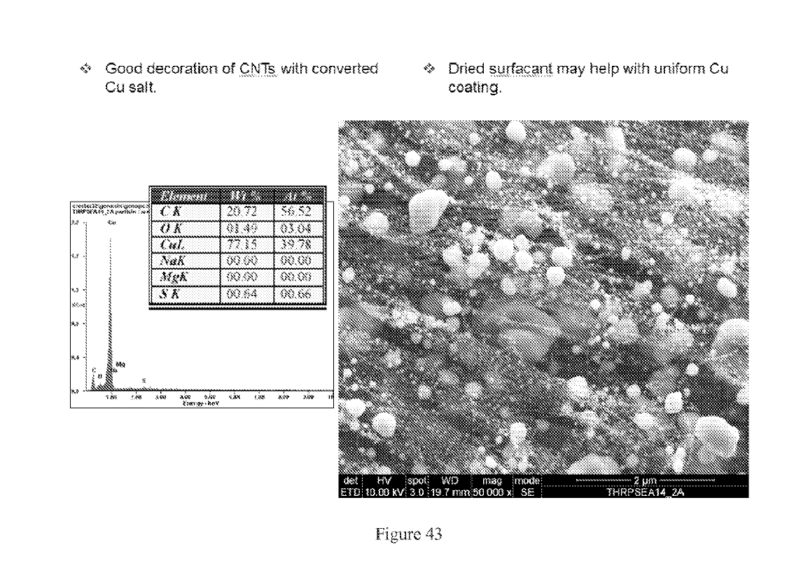

FIG. 43 provides an elemental analysis and an image of a CNT-coated wire that has been decorated with Cu particles from a converted Cu salt. Without being bound to any particular theory, it is believed that dried surfactant—present in these samples—may help to effect a more uniform Cu (or other particle) coating.

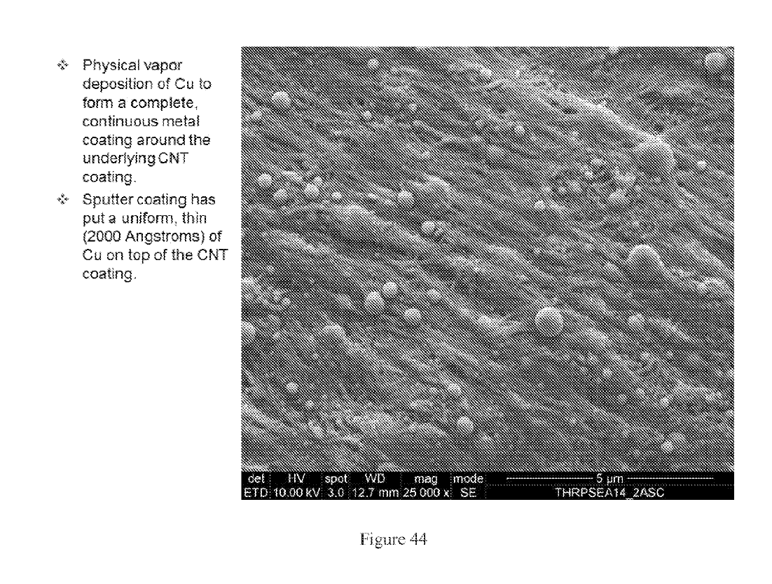

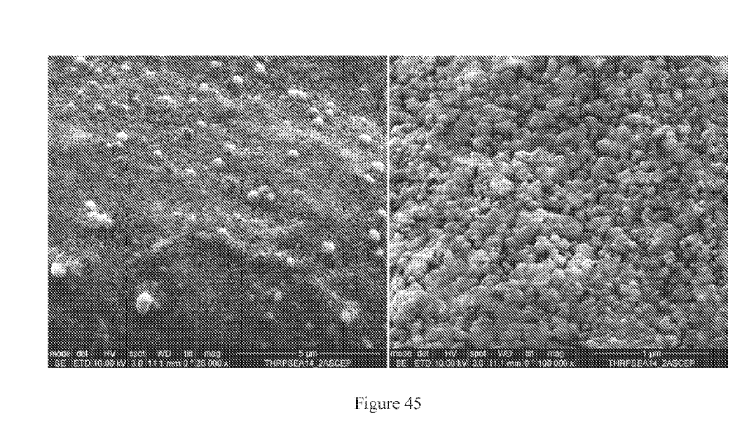

FIG. 44 presents an image from an alternative embodiment—a CNT-coated wire that has undergone a physical vapor deposition process to form a metal matrix around the underlying CNT coating. Physical vapor deposition (as well as chemical vapor deposition (CVD) processes) may be used to deposit such a matrix. Sputter coating may be used to place a metallic coating atop a CNT coating. FIG. 45 presents images of another alternative embodiment in which a copper film has been electroplated atop a CNT coating.

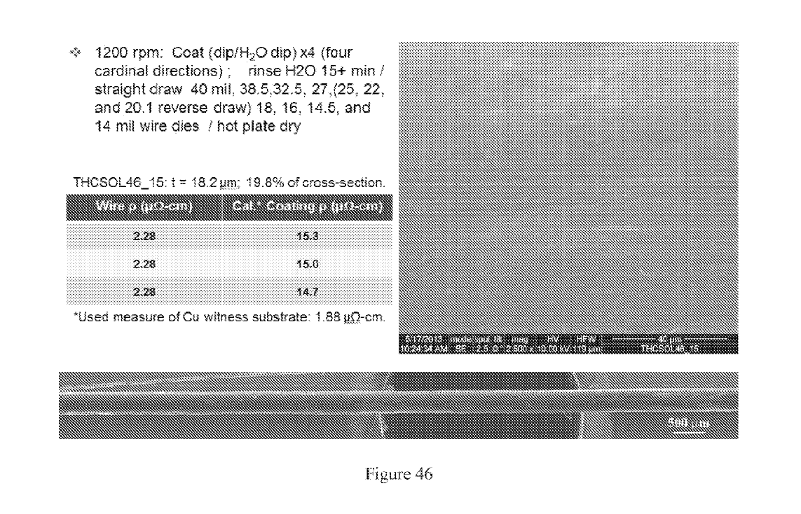

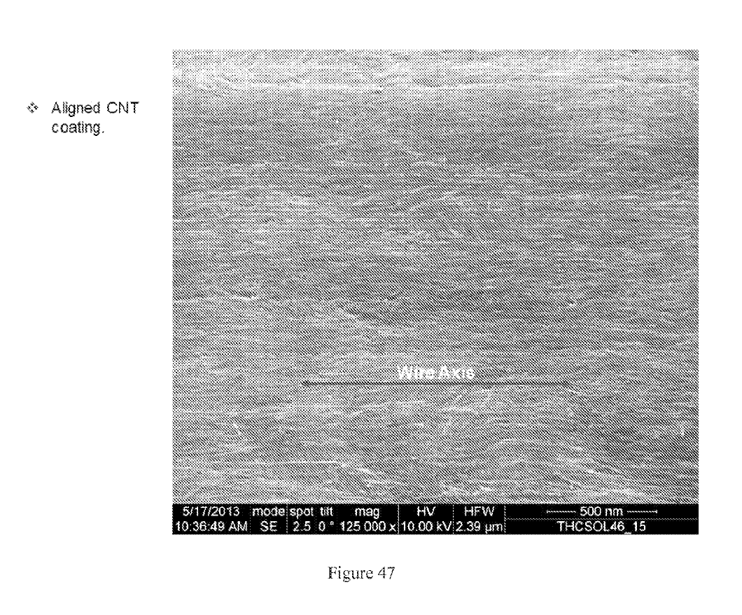

FIG. 46 provides an image and electrical properties for a sample that has been prepared using lab-made MWNTs dispersed in an all-acid dispersion solution. FIG. 47 provides a magnified image of this sample, showing the CNT alignment.

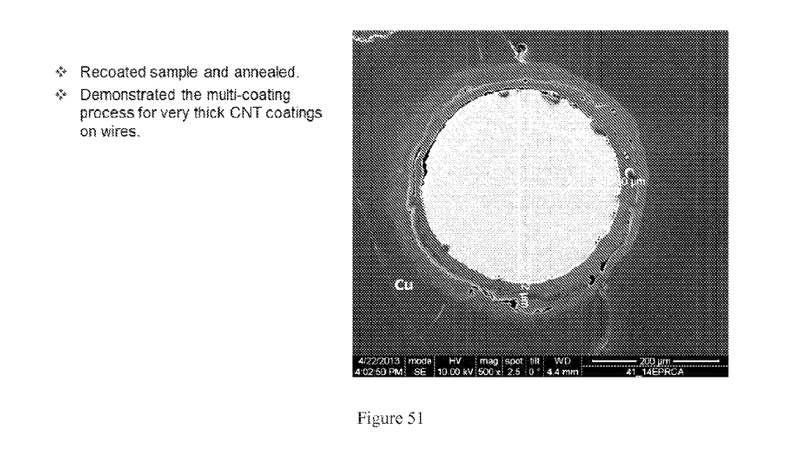

FIG. 48 provides a data table that summarizes electrical properties for a sample prepared by application of multiple CNTs (DWNT and SWNT). The sample also featured an electroplated Cu coating atop the CNT coating. FIG. 49 provides an image of a CNT coating from an all acid solution that contains a mixture of MWNTs and DWNTs; FIG. 50 provides additional imagery of the sample. FIG. 51 provides a cross-sectional image of a sample that has been recoated and annealed, with a Cu coating atop the CNT coating.

It should be understood that although the term “wire” has been used in this disclosure in connection with describing exemplary embodiments of the disclosed composites, the substrate need not have a wire form. As an example, the substrate may be in the form of a tape (having a width greater than its height) or even in the form of a tube.

1. A conductive structure, comprising:
an elongate substrate surmounted by a coating comprising carbon nanotubes,
the elongate substrate having a major axis, and
at least a portion of the carbon nanotubes of the coating being aligned with the major axis.

2. The conductive structure of claim 1, wherein the substrate defines an aspect ratio in the range of from about 1:5 to about 1:1,000,000.

3. The conductive structure of claim 1, wherein the elongate substrate comprises a metal, a ceramic, a polymer, or any combination thereof.

4. The conductive structure of claim 1, wherein the elongate substrate comprises copper, aluminum, or both.

5. The conductive structure of claim 3, wherein the elongate substrate comprises boron.

6. The conductive structure of claim 1, wherein the substrate defines a cross-sectional dimension in the range of from about 0.05 mm to about 5 mm.

7. The conductive structure of claim 1, wherein the substrate defines a length along the major axis of at least about 10 cm.

8-21. (canceled)

22. A method of forming a conductive structure, comprising:
contacting (a) an elongate substrate and (b) a population of carbon nanotubes dispersed in a fluid medium so as to give rise to an article having a coating of nanotubes that surmounts at least a portion of the elongate substrate; and
drawing the article so as to reduce a cross-sectional dimension of the article.

23. The method of claim 22, wherein the drawing comprises linear motion.

24. The method of claim 22, wherein the drawing comprises twisting.

25. The method of claim 22, wherein the population of carbon nanotubes is dispersed in a fluid medium.

26. The method of claim 22, wherein the population of carbon nanotubes comprises at least two carbon nanotubes that differ from one another in terms of number of walls, cross-sectional dimension, surface functionality, or any combination thereof.

27. The method of claim 22, wherein at least some of the carbon nanotubes have a length in the at least about 5 microns to about 5 mm.

28-37. (canceled)

38. A conductive structure, comprising:
a assemblage of carbon nanotubes, the assemblage being characterized as being essentially tubular in configuration, the assemblage having a major axis, and at least some of the carbon nanotubes being oriented along the major axis.

39. The conductive structure of claim 38, wherein the assemblage defines a thickness in the range of from about 0.5 microns to about 2 mm.

40. The conductive structure of claim 38, wherein at least some of the carbon nanotubes have a length in the direction of the major axis of at least about 5 microns to about 5 mm.

41. The conductive structure of claim 38, wherein the assemblage comprises single-wall and multi-wall carbon nanotubes.

42. The conductive structure of claim 41, wherein the ratio, by number, of single-wall to multi-wall carbon nanotubes in the assemblage is in the range of from about 1:100 to about 100:1.

43. The conductive structure of claim 41, wherein the ratio, by number, of single-wall to multi-wall carbon nanotubes in the assemblage is in the range of from about 1:10 to about 10:1.

44. The conductive structure of claim 38, wherein at least some of the carbon nanotubes have a cross-sectional dimension in the range of from about 2 nm to about 200 nm.

45-61. (canceled)
